(19) United States
(12) Patent Application Publication
(10) Pub. No.: US 2025/0155596 A1
(43) Pub. Date: May 15, 2025

(54) REFLECTION SEISMOLOGY FRAMEWORK

(71) Applicant: Schlumberger Technology Corporation, Sugar Land, TX (US)

(72) Inventors: Zongcai Feng, Houston, TX (US); Xin Cheng, Houston, TX (US); Mohamed Hegazy, Houston, TX (US); Denes Vigh, Houston, TX (US)

(21) Appl. No.: 18/941,639

(22) Filed: Nov. 8, 2024

Related U.S. Application Data
(60) Provisional application No. 63/597,786, filed on Nov. 10, 2023.

(51) Int. Cl. G01V 1/28; G01V 1/30

(52) U.S. Cl. CPC G01V 1/282; G01V 1/30; G01V 2210/512

(57) ABSTRACT

A method can include receiving seismic data of a seismic survey of a subsurface region; performing a full waveform inversion using the seismic data and a model of the subsurface region to determine one or more characteristics of the subsurface region, where the model of the subsurface region includes one or more angle-dependent model parameters; and outputting the one or more characteristics of the subsurface region.

### RELATED APPLICATIONS

This application claims priority to and the benefit of a U.S. Provisional Application having Ser. No. 63/597,786, filed 10 Nov. 2023, which is incorporated by reference herein.

### BACKGROUND

Reflection seismology finds use in geophysics, for example, to estimate properties of subsurface formations (e.g., to characterize a subterranean environment with one or more formations). As an example, reflection seismology may provide seismic data representing waves of elastic energy (e.g., as transmitted by P-waves and S-waves, in a frequency range of approximately 1 Hz to approximately 100 Hz). Seismic data may be processed and interpreted, for example, to understand better composition, fluid content, extent and geometry of subsurface rocks. Propagation of seismic energy, as in reflection seismology, can depend on one or more characteristics of a subsurface medium or media. Reflection seismology data can be used to understand or characterize one or more subsurface formations.

### SUMMARY

A method can include receiving seismic data of a seismic survey of a subsurface region; performing a full waveform inversion using the seismic data and a model of the subsurface region to determine one or more characteristics of the subsurface region, where the model of the subsurface region includes one or more angle-dependent model parameters; and outputting the one or more characteristics of the subsurface region. A system can include a processor; memory accessible by the processor; and processor-executable instructions stored in the memory that are executable to instruct the system to: receive seismic data of a seismic survey of a subsurface region; perform a full waveform inversion using the seismic data and a model of the subsurface region to determine one or more characteristics of the subsurface region, where the model of the subsurface region includes one or more angle-dependent model parameters; and output the one or more characteristics of the subsurface region. One or more computer-readable storage media can include computer-executable instructions executable to instruct a computer to: receive seismic data of a seismic survey of a subsurface region; perform a full waveform inversion using the seismic data and a model of the subsurface region to determine one or more characteristics of the subsurface region, where the model of the subsurface region includes one or more angle-dependent model parameters; and output the one or more characteristics of the subsurface region. Various other examples of methods, devices, systems, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of a framework and an example of a geologic environment;

FIG. 2 illustrates examples of signals, an example of a technique and

examples of multiple reflections;

FIG. 3 illustrates examples of survey techniques;

FIG. 4 illustrates examples of survey techniques;

FIG. 5 illustrates examples of methods;

FIG. 6 illustrates an example of a method;

FIG. 7 illustrates examples of graphics;

FIG. 8 illustrates examples of graphics;

FIG. 9 illustrates an example of a method;

FIG. 10 illustrates examples of graphics;

FIG. 11 illustrates an example of a method and an example of a system;

FIG. 12 illustrates an example of a computational framework; and

FIG. 13 illustrates example components of a system and a networked system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

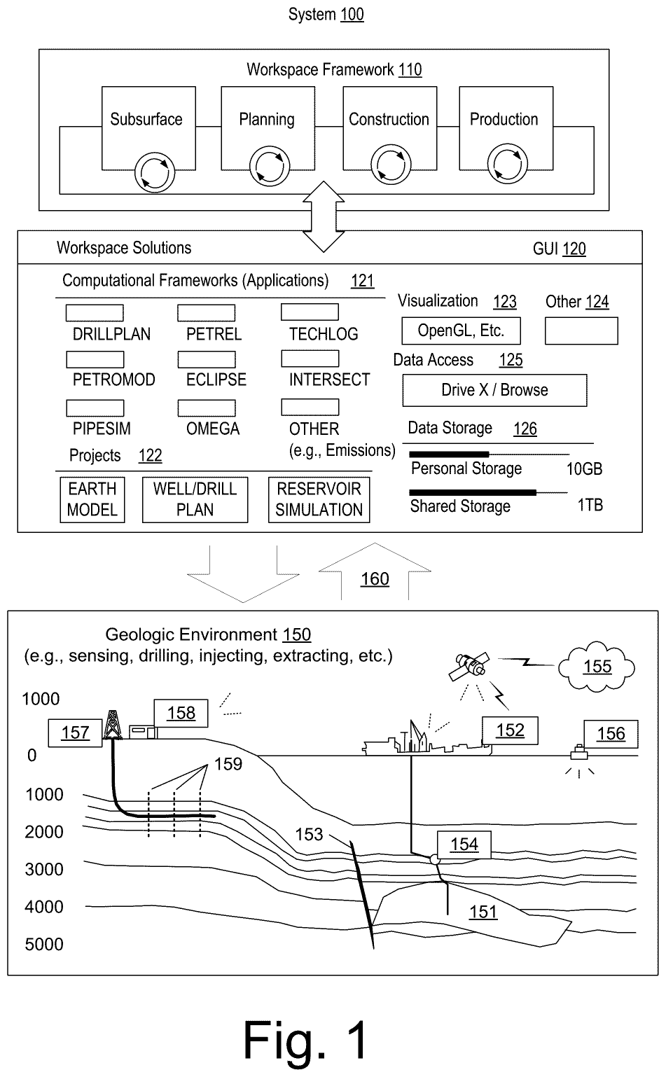

FIG. 1 shows an example of a system 100 that includes a workspace framework 110 that can provide for instantiation of, rendering of, interactions with, etc., a graphical user interface (GUI) 120. In the example of FIG. 1, the GUI 120 can include graphical controls for computational frameworks (e.g., applications) 121, projects 122, visualization 123, one or more other features 124, data access 125, and data storage 126.

In the example of FIG. 1, the workspace framework 110 may be tailored to a particular geologic environment such as an example geologic environment 150. For example, the geologic environment 150 may include layers (e.g., stratification) that include a reservoir 151 and that may be intersected by a fault 153. As an example, the geologic environment 150 may be outfitted with a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a wellsite and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or alternatively include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

In the example of FIG. 1, the GUI 120 shows some examples of computational frameworks, including the DRILLPLAN, PETREL, TECHLOG, PETROMOD, ECLIPSE, INTERSECT, PIPESIM and OMEGA frameworks (SLB, Houston, Texas). As to another type of framework, consider, for example, an emissions framework (EF), which may be operable in combination with one or more other frameworks to make determinations as to emissions (e.g., of one or more field operations, etc.). In such an example, an EF may provide feedback such that another framework can operate on output of the EF, for example, to revise a plan, revise a control scheme, etc., which may be in a manner that aims to reduce one or more types of emissions and/or other impact from an activity, etc.

The DRILLPLAN framework provides for digital well construction planning and includes features for automation of repetitive tasks and validation workflows, enabling improved quality drilling programs (e.g., digital drilling plans, etc.) to be produced quickly with assured coherency.

The PETREL framework can be part of the DELFI cognitive E&P environment (SLB, Houston, Texas) for utilization in geosciences and geoengineering, for example, to analyze subsurface data from exploration to production of fluid from a reservoir.

The TECHLOG framework can handle and process field and laboratory data for a variety of geologic environments (e.g., deepwater exploration, shale, etc.). The TECHLOG framework can structure wellbore data for analyses, planning, etc.

The PETROMOD framework provides petroleum systems modeling capabilities that can combine one or more of seismic, well, and geological information to model the evolution of a sedimentary basin. The PETROMOD framework can predict if, and how, a reservoir has been charged with hydrocarbons, including the source and timing of hydrocarbon generation, migration routes, quantities, and hydrocarbon type in the subsurface or at surface conditions.

The ECLIPSE framework provides a reservoir simulator (e.g., as a computational framework) with numerical solutions for fast and accurate prediction of dynamic behavior for various types of reservoirs and development schemes.

The INTERSECT framework provides a high-resolution reservoir simulator for simulation of detailed geological features and quantification of uncertainties, for example, by creating accurate production scenarios and, with the integration of precise models of the surface facilities and field operations, the INTERSECT framework can produce reliable results, which may be continuously updated by real-time data exchanges (e.g., from one or more types of data acquisition equipment in the field that can acquire data during one or more types of field operations, etc.). The INTERSECT framework can provide completion configurations for complex wells where such configurations can be built in the field, can provide detailed chemical-enhanced-oil-recovery (EOR) formulations where such formulations can be implemented in the field, can analyze application of steam injection and other thermal EOR techniques for implementation in the field, advanced production controls in terms of reservoir coupling and flexible field management, and flexibility to script customized solutions for improved modeling and field management control. The INTERSECT framework, as with the other example frameworks, may be utilized as part of the DELFI cognitive E&P environment, for example, for rapid simulation of multiple concurrent cases. For example, a workflow may utilize one or more of the DELFI on demand reservoir simulation features.

The PIPESIM simulator includes solvers that may provide simulation results such as, for example, multiphase flow results (e.g., from a reservoir to a wellhead and beyond, etc.), flowline and surface facility performance, etc. The PIPESIM simulator may be integrated, for example, with the AVOCET production operations framework (SLB, Houston Texas). As an example, a reservoir or reservoirs may be simulated with respect to one or more enhanced recovery techniques (e.g., consider a thermal process such as steam-assisted gravity drainage (SAGD), etc.). As an example, the PIPESIM simulator may be an optimizer that can optimize one or more operational scenarios at least in part via simulation of physical phenomena.

The OMEGA framework includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density. The OMEGA framework also includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools. Various features can be included for processing various types of data such as, for example, one or more of: land, marine, and transition zone data; time and depth data; 2D, 3D, and 4D surveys; isotropic and anisotropic (TTI and VTI) velocity fields; and multicomponent data.

The aforementioned DELFI environment provides various features for workflows as to subsurface analysis, planning, construction and production, for example, as illustrated in the workspace framework 110. As shown in FIG. 1, outputs from the workspace framework 110 can be utilized for directing, controlling, etc., one or more processes in the geologic environment 150 and, feedback 160, can be received via one or more interfaces in one or more forms (e.g., acquired data as to operational conditions, equipment conditions, environment conditions, etc.).

As an example, a workflow may progress to a geology and geophysics (“G&G”) service provider, which may generate a well trajectory, which may involve execution of one or more G&G software packages. Examples of such software packages include the PETREL framework. As an example, a system or systems may utilize a framework such as the DELFI framework (SLB, Houston, Texas). Such a framework may operatively couple various other frameworks to provide for a multi-framework workspace. As an example, the GUI 120 of FIG. 1 may be a GUI of the DELFI framework.

In the example of FIG. 1, the visualization features 123 may be implemented via the workspace framework 110, for example, to perform tasks as associated with one or more of subsurface regions, planning operations, constructing wells and/or surface fluid networks, and producing from a reservoir.

As an example, visualization features can provide for visualization of various earth models, properties, etc., in one or more dimensions. As an example, visualization features can provide for rendering of information in multiple dimensions, which may optionally include multiple resolution rendering. In such an example, information being rendered may be associated with one or more frameworks and/or one or more data stores. As an example, visualization features may include one or more control features for control of equipment, which can include, for example, field equipment that can perform one or more field operations. As an example, a workflow may utilize one or more frameworks to generate information that can be utilized to control one or more types of field equipment (e.g., drilling equipment, wireline equipment, fracturing equipment, etc.).

As to a reservoir model that may be suitable for utilization by a simulator, consider acquisition of seismic data as acquired via reflection seismology, which finds use in geophysics, for example, to estimate properties of subsurface formations. As an example, reflection seismology may provide seismic data representing waves of elastic energy (e.g., as transmitted by P-waves and S-waves, in a frequency range of approximately 1 Hertz (Hz) to approximately 100 Hz). Seismic data may be processed and interpreted, for example, to understand better composition, fluid content, extent and geometry of subsurface rocks. Such interpretation results can be utilized to plan, simulate, perform, etc., one or more operations for production of fluid from a reservoir (e.g., reservoir rock, etc.).

Field acquisition equipment may be utilized to acquire seismic data, which may be in the form of traces where a trace can include values organized with respect to time and/or depth (e.g., consider 1D, 2D, 3D or 4D seismic data). For example, consider acquisition equipment that acquires digital samples at a rate of one sample per approximately 4 milliseconds (ms). Given a speed of sound in a medium or media, a sample rate may be converted to an approximate distance. For example, the speed of sound in rock may be on the order of around 5 kilometer (“km”) per second. Thus, a sample time spacing of approximately 4 ms would correspond to a sample “depth” spacing of about 10 meters (e.g., assuming a path length from source to boundary and boundary to sensor). As an example, a trace may be about 4 seconds in duration; thus, for a sampling rate of one sample at about 4 ms intervals, such a trace would include about 1000 samples where latter acquired samples correspond to deeper reflection boundaries. If the 4 second trace duration of the foregoing example is divided by two (e.g., to account for reflection), for a vertically aligned source and sensor, a deepest boundary depth may be estimated to be about 10 km (e.g., assuming a speed of sound of about 5 km per second).

As an example, a model may be a simulated version of a geologic environment. As an example, a simulator may include features for simulating physical phenomena in a geologic environment based at least in part on a model or models. A simulator, such as a reservoir simulator, can simulate fluid flow in a geologic environment based at least in part on a model that can be generated via a framework that receives seismic data. A simulator can be a computerized system (e.g., a computing system) that can execute instructions using one or more processors to solve a system of equations that describe physical phenomena subject to various constraints. In such an example, the system of equations may be spatially defined (e.g., numerically discretized) according to a spatial model that that includes layers of rock, geobodies, etc., that have corresponding positions that can be based on interpretation of seismic and/or other data. A spatial model may be a cell-based model where cells are defined by a grid (e.g., a mesh). A cell in a cell-based model can represent a physical area or volume in a geologic environment where the cell can be assigned physical properties (e.g., permeability, fluid properties, etc.) that may be germane to one or more physical phenomena (e.g., fluid volume, fluid flow, pressure, etc.). A reservoir simulation model can be a spatial model that may be cell-based.

A simulator can be utilized to simulate the exploitation of a real reservoir, for example, to examine different productions scenarios to find an optimal one before production or further production occurs. A reservoir simulator does not provide an exact replica of flow in and production from a reservoir at least in part because the description of the reservoir and the boundary conditions for the equations for flow in a porous rock are generally known with an amount of uncertainty. Certain types of physical phenomena occur at a spatial scale that can be relatively small compared to size of a field. A balance can be struck between model scale and computational resources that results in model cell sizes being of the order of meters; rather than a lesser size (e.g., a level of detail of pores). A modeling and simulation workflow for multiphase flow in porous media (e.g., reservoir rock, etc.) can include generalizing real micro-scale data from macro scale observations (e.g., seismic data and well data) and upscaling to a manageable scale and problem size. Uncertainties can exist in input data and solution procedure such that simulation results too are to some extent uncertain. A process known as history matching can involve comparing simulation results to actual field data acquired during production of fluid from a field. Information gleaned from history matching, can provide for adjustments to a model, data, etc., which can help to increase accuracy of simulation.

As an example, a simulator may utilize various types of constructs, which may be referred to as entities. Entities may include earth entities or geological objects such as wells, surfaces, reservoirs, etc. Entities can include virtual representations of actual physical entities that may be reconstructed for purposes of simulation. Entities may include entities based on data acquired via sensing, observation, etc. (e.g., consider entities based at least in part on seismic data and/or other information). As an example, an entity may be characterized by one or more properties (e.g., a geometrical pillar grid entity of an earth model may be characterized by a porosity property, etc.). Such properties may represent one or more measurements (e.g., acquired data), calculations, etc.

As an example, a simulator may utilize an object-based software framework, which may include entities based on pre-defined classes to facilitate modeling and simulation. As an example, an object class can encapsulate reusable code and associated data structures. Object classes can be used to instantiate object instances for use by a program, script, etc. For example, borehole classes may define objects for representing boreholes based on well data. A model of a basin, a reservoir, etc. may include one or more boreholes where a borehole may be, for example, for measurements, injection, production, etc. As an example, a borehole may be a wellbore of a well, which may be a completed well (e.g., for production of a resource from a reservoir, for injection of material, etc.).

While several simulators are illustrated in the example of FIG. 1, one or more other simulators may be utilized, additionally or alternatively. For example, consider the VISAGE geomechanics simulator (SLB, Houston Texas), etc. The VISAGE simulator includes finite element numerical solvers that may provide simulation results such as, for example, results as to compaction and subsidence of a geologic environment, well and completion integrity in a geologic environment, cap-rock and fault-seal integrity in a geologic environment, fracture behavior in a geologic environment, thermal recovery in a geologic environment, CO₂ disposal, etc. The MANGROVE simulator (SLB, Houston, Texas) provides for optimization of stimulation design (e.g., stimulation treatment operations such as hydraulic fracturing) in a reservoir-centric environment. The MANGROVE framework can combine scientific and experimental work to predict geomechanical propagation of hydraulic fractures, reactivation of natural fractures, etc., along with production forecasts within 3D reservoir models (e.g., production from a drainage area of a reservoir where fluid moves via one or more types of fractures to a well and/or from a well). The MANGROVE framework can provide results pertaining to heterogeneous interactions between hydraulic and natural fracture networks, which may assist with optimization of the number and location of fracture treatment stages (e.g., stimulation treatment(s)), for example, to increased perforation efficiency and recovery.

As mentioned, a framework may be implemented within or in a manner operatively coupled to the DELFI cognitive exploration and production (E&P) environment (SLB, Houston, Texas), which is a secure, cognitive, cloud-based collaborative environment that integrates data and workflows with digital technologies, such as artificial intelligence and machine learning. As an example, such an environment can provide for operations that involve one or more frameworks. The DELFI environment may be referred to as the DELFI framework, which may be a framework of frameworks. As an example, the DELFI framework can include various other frameworks, which can include, for example, one or more types of models (e.g., simulation models, etc.).

As mentioned, reflection seismology finds use in geophysics, for example, to estimate properties of subsurface formations. As an example, reflection seismology may provide seismic data representing waves of elastic energy (e.g., as transmitted by P-waves and S-waves, in a frequency range of approximately 1 Hz to approximately 100 Hz or optionally less than 1 Hz and/or optionally more than 100 Hz). Seismic data may be processed and interpreted, for example, to understand better composition, fluid content, extent and geometry of subsurface rocks.

Digital images of a subsurface region of the Earth can be generated using digital seismic data acquired using reflection seismology as part of a seismic survey. A digital image can show subterranean structure, for example, as related to one or more of exploration for petroleum, natural gas, and mineral deposits. As an example, reflection seismology can include determining time intervals that elapse between initiation of a seismic wave at a selected shot point (e.g., the location where an explosion generates seismic waves) and the arrival of reflected or refracted impulses at one or more seismic detectors (e.g., sensing of seismic energy at one or more seismic receivers). As an example, a seismic air gun can be used to initiate seismic waves. As an example, one or more electric vibrators or falling weights (e.g., thumpers) may be employed at one or more sites. Upon arrival at the detectors, the amplitude and timing of seismic energy waves can be recorded, for example, as a seismogram (e.g., a record of ground vibrations).

In various regions of the Earth, the material density (e.g., rock density) increases with depth. Seismic energy waves can be initiated at a shot point (or points) at or near the surface where a portion of the seismic energy, as waves, may reach one or more receiving points. Material properties and structural organization of materials (e.g., as objects, layers, etc.) can affect seismic energy waves in one or more manners. Received seismic energy waves can be utilized to determine one or more types of material properties and/or structural organization of one or more types of materials. As with sound traveling through air or water, seismic energy waves can be attenuated as they pass through subsurface materials, which may include air, water, hydrocarbons, rock, etc. Such attenuation can occur in a manner that is dependent on material properties of such materials.

Interpretation of the depths and media reached by seismic energy waves can depend on geometry of a seismic survey, for example, on the distance between shot points and receiving points, as well as densities of media. Results of a seismic survey may be in digital form (e.g., digital data) as stored in memory of a computing device where display circuitry (e.g., a graphics processor, a video processor, etc.) can render the digital data to a display in the form of a cross-sectional image of subsurface structures as if cut by a plane through the shot point, the detector, and a reference point such as the Earth's center. As an example, digital image processing can involve receiving seismic data as digital data, processing the seismic data via one or more techniques, and rendering processed seismic data to a display as an image of a region of the Earth that can show structural features of the Earth that otherwise are not visible from an observer standing on the surface of the Earth.

A seismic survey can be defined with respect to a region of the Earth and, for example, a manner of acquisition of seismic data. As an example, a survey may be two-dimensional, three-dimensional, four-dimensional, etc. Dimensions include one or more spatial dimensions and optionally one or more temporal dimensions (e.g., repeating a survey for a region at different points in time). As to a 2D survey, a grid may be considered dense if the line spacing (e.g., of receivers) is less than about 400 meters (“m”). As to a 3D spatial survey, in comparison to a 2D spatial survey, it may help to elucidate true structural dip (e.g., a 2D survey may give apparent dip), it may provide more and better stratigraphic information, it may provide a map view of reservoir properties, it may provide a better areal mapping of fault patterns and connections and delineation of reservoir blocks, it may provide better lateral resolution (e.g., 2D may suffer from a cross-line smearing, or Fresnel zone, problem).

As to data sets, a 3D spatial seismic data set can be a cube or volume of data. As an example, a 2D spatial seismic data set can be a panel of data. To interpret 3D seismic data, a method can process the “interior” of the cube (e.g., seismic cube) using one or more processors of computing equipment. As an example, a 3D seismic data set can range in size from a few tens of megabytes to several gigabytes or more.

As to a 3D seismic cube, a point can have an (x, y, z) coordinate and a data value. A coordinate can be a distance from a particular corner of the cube. A 3D seismic data volume is like a room-temperature example (e.g., where temperature differs in a cube shaped room), however, rather than a height of a room, a height or vertical axis can be in terms of a two-way traveltime, which may be a proxy for depth. In such an example, the 3D seismic cube is still a spatial cube because the data therein correspond to the same survey where, rather than depth, two-way traveltime (TWT) is utilized, which, can be, in general, a proxy for depth. And, in contrast to room-temperature, data values can be seismic amplitudes (e.g., amplitudes of seismic energy waves). A 3D seismic data set can be, for example, a box full of electronically determined numbers where each number represents a measurement (e.g., amplitude of a seismic energy wave, etc.). In a 3D seismic data set, amplitudes may be rendered as data values in the form of one or more images for slices through the 3D seismic data set where, for example, in grayscale, dark and light image bands in the sections are related to rock boundaries.

Reflection seismology can be implemented as a technique that detects “edges” of materials in the Earth. An image generated utilizing reflection seismology can show such edges of materials, which can be equated to positions in the Earth such that one may know where an edge of a material is in the Earth. For example, where the edge corresponds to a hydrocarbon reservoir, a method can include drilling to the reservoir in a manner guided by the position of the edge. As an example, a drilling process can be manual, semi-automated or automated where positional information as to an edge of a material in the Earth can be utilized to guide drilling equipment that forms a bore in the Earth where the bore may be directed to the edge or to a region that is defined at least in part by the edge. Where reflection seismology is improved, such an “edge” may be detected more readily and/or with greater accuracy (e.g., resolution), which, in turn, can improve one or more field processes such as a drilling process. For example, consider directional drilling where an edge may be a boundary of a pay zone of hydrocarbons where a drillstring may be controlled to be within the pay zone based at least in part on the location of the edge. As an example, an edge may be a formation boundary or other object boundary that may be utilized in determining where to drill. As explained, drilling may be performed using equipment where such equipment may be controlled to form a borehole that is positioned with respect to one or more edges, as may be discerned using seismic data, etc.

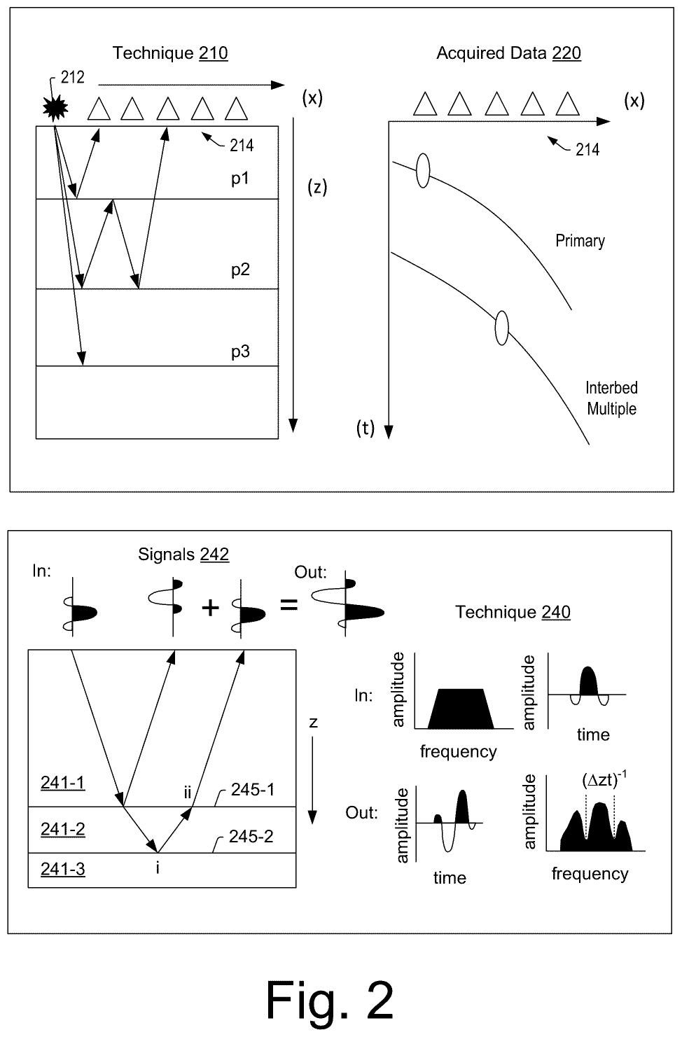

FIG. 2 shows an example of a technique 210 and acquired data 220, an example of a technique 240, and signals 242. As mentioned, a survey can include utilizing a source or sources and receivers. In the example technique 210, a source 212 is illustrated along with a plurality of receivers 214 that are spaced along a direction defined as an inline direction x. Along the inline direction x, distances can be determined between the source 212 and each of the receivers 214.

A subsurface region being surveyed includes features such a surface and subsurface horizons p1, p2 and p3 where one or more of such structural features can be interfaces where elastic properties can differ such that seismic energy is at least in part reflected. For example, a horizon can be an interface that might be represented by a seismic reflection, such as the contact between two bodies of rock having different seismic velocity, density, porosity, fluid content, etc. In the example of FIG. 2, the technique 210 is shown to generate seismic reflections, which can include singly reflected and multiply reflected seismic energy. The acquired data 220 illustrate energy received by the receivers 214 with respect to time, t, and their inline position along the x-axis. As shown, singly reflected energy can be defined as primary (or primaries) while multiply reflected energy can be defined as multiples such as surface multiples, interbed multiples (e.g., IM), etc.

A primary can be defined as a seismic event whose energy has been reflected once; whereas, a multiple can be defined as an event whose energy has been reflected more than once. With respect to seismic interpretation, whether manual, semi-automatic or automatic, various techniques may aim to enhance primary reflections to facilitate interpretation of one or more subsurface interfaces. In other words, multiples can be viewed as extraneous signal or noise that can interfere with an interpretation process. As an example, one or more method can utilize multiples to provide useful signals. For example, consider a seismic survey designed to increase seismic signal coverage of a subsurface region of the Earth through use of multiples.

Where multiples are considered undesirable, a process that aims to attenuate the presence of multiples (e.g., the presence of information in seismic data that corresponds to multiple energy) may include an adaptive subtraction process. An adaptive subtraction process can include modeling of multiples to generate a model (e.g., a multiples model) followed by subtracting the model from the acquired data. A technique that can be used for attenuation of multiples may be the extended internal multiple prediction (XIMP), which is a data-driven multiple-modeling approach for prediction of internal multiples from recorded events using wavefield extrapolation, for example, based on the Kirchhoff integral.

In FIG. 2, the technique 240 can include emitting energy with respect to time where the energy may be represented in a frequency domain, for example, as a band of frequencies. In such an example, the emitted energy may be a wavelet and, for example, referred to as a source wavelet which has a corresponding frequency spectrum (e.g., per a Fourier transform of the wavelet).

A wavelet can be a one-dimensional pulse defined by attributes such as, for example, amplitude, frequency and phase. A wavelet can originate as a packet of energy from a source point, having a specific origin in time, and be returned to one or more receivers as a series of events distributed in time and energy. The distribution is a function of velocity and density changes in the subsurface and the relative position of the source and receiver. Energy that returns cannot exceed what was input, so the energy in a received wavelet decays with time, for example, as more partitioning takes place at interfaces. Wavelets can also decay due to loss of energy as heat during propagation, which can be more extensive at higher frequencies. In various instances, received wavelets can tend to contain less high-frequency energy relative to low frequencies at longer traveltimes. Some wavelets are known by their shape and spectral content, such as the Ricker wavelet (e.g., a zero-phase wavelet such as the second derivative of the Gaussian function or the third derivative of the normal-probability density function).

As an example, a geologic environment may include layers 241-1, 241-2 and 241-3 where an interface 245-1 exists between the layers 241-1 and 241-2 and where an interface 245-2 exists between the layers 241-2 and 241-3. As an example, an interface may be identified as an edge, for example, a boundary of a layer, etc. As illustrated in FIG. 2, a wavelet may be first transmitted downward in the layer 241-1; be, in part, reflected upward by the interface 245-1 and transmitted upward in the layer 241-1; be, in part, transmitted through the interface 245-1 and transmitted downward in the layer 241-2; be, in part, reflected upward by the interface 245-2 (see, e.g., “i”) and transmitted upward in the layer 241-2; and be, in part, transmitted through the interface 245-1 (see, e.g., “ii”) and again transmitted in the layer 241-1. In such an example, signals (see, e.g., the signals 262) may be received as a result of wavelet reflection from the interface 245-1 and as a result of wavelet reflection from the interface 245-2. These signals may be shifted in time and in polarity such that addition of these signals results in a waveform that may be analyzed to derive some information as to one or more characteristics of the layer 241-2 (e.g., and/or one or more of the interfaces 245-1 and 245-2). For example, a Fourier transform of signals may provide information in a frequency domain that can be used to estimate a temporal thickness (e.g., Δzt) of the layer 241-2 (e.g., as related to acoustic impedance, reflectivity, etc.).

As explained, interbed multiple signals may be received by one or more receivers over a period of time in a manner that acts to “sum” their amplitudes with amplitudes of other signals. In such an example, the additional interbed signals may interfere with an analysis that aims to determine one or more characteristics of the layer 241-2 (e.g., and/or one or more of the interfaces 245-1 and 245-2). For example, interbed multiple signals may interfere with identification of a layer, an interface, interfaces, etc. (e.g., consider an analysis that determines temporal thickness of a layer, etc.).

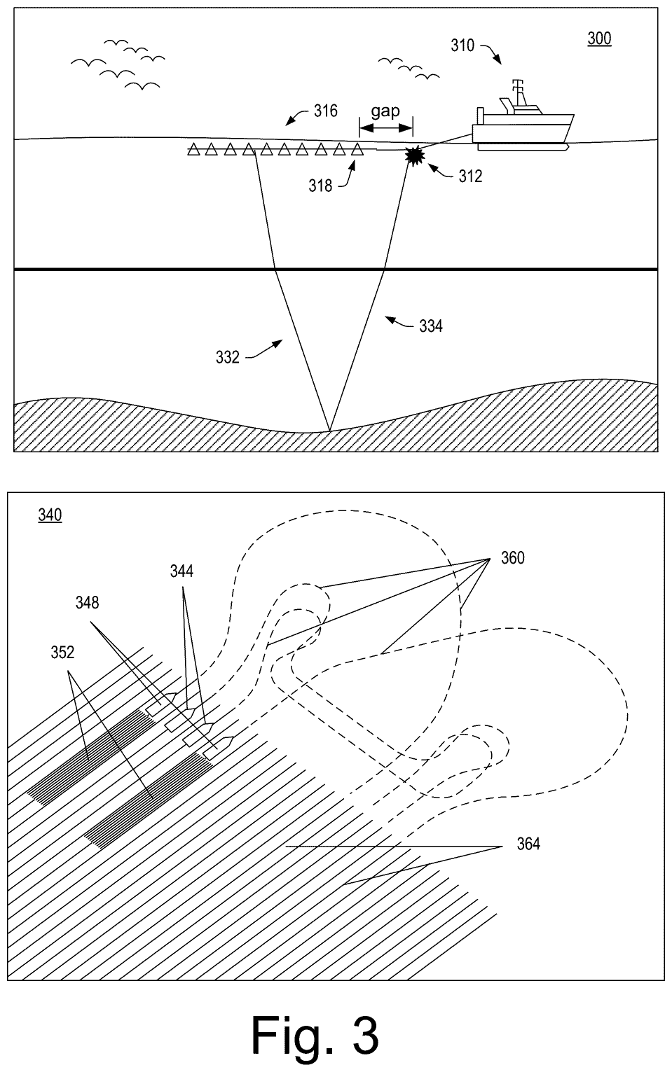

FIG. 3 shows an example of a simplified schematic view of a marine seismic acquisition system for a single vessel 300 and an example of a simplified schematic view of a marine seismic data acquisition system for multiple vessels 340.

In FIG. 3, the system 300 includes equipment 310, which can be a vessel that tows one or more sources 312 and one or more streamers 316 (e.g., with receivers 318). In the system 300, at least one of the one or more sources 312 of the equipment 310 can emit energy at a location and at least one of the receivers 318 of the equipment 310 can receive energy at a location. The emitted energy can be at least in part along a path of the downgoing energy 332 and the received energy can be at least in part along a path of the upgoing energy 334.

In various systems, for one or more reasons, a gap in coverage may exist. For example, in the system 300 a gap is identified and labeled where the gap may be defined as a distance between a seismic source and a seismic receiver. In such an example, the distance may be considered a practical or a safe distance for locating a seismic receiver from a seismic source. If a seismic receiver is too close to a seismic source, the seismic receiver may experience a rather large shock wave and/or may otherwise experience energy that may be quite high and raise concerns with calibration, dynamic range, etc.

In the system 340 of FIG. 3, one or more source vessels 340 may be utilized with one or more streamer vessels 348 or a vessel or vessels may tow both a source or sources and a streamer or streamers 352. As an example, a marine survey may utilize one or more types of receivers such as, for example, towed receivers on streamers and ocean bottom receivers on cables and/or nodes (e.g., OBCs and/or OBNs).

In the example of FIG. 3, the vessels 344 and 348 (e.g., or just the vessels 348 if they include sources) may follow predefined routes (e.g., paths) for an acquisition geometry that includes inline and crossline dimensions. As shown, routes 360 can be for maneuvering the vessels to positions 364 as part of the survey. As an example, a marine seismic survey may call for acquiring seismic data during a turn (e.g., during one or more of the routes 360).

The example systems 300 and 340 of FIG. 3 demonstrate how surveys may be performed according to an acquisition geometry that includes dimensions such as inline and crossline dimensions, which may be defined as x and y dimensions in a plane or surface where another dimension, z, is a depth dimension. As explained, time can be a proxy for depth, depending on various factors, which can include knowing how many reflections may have occurred as a single reflection may mean that depth of a reflector can be approximated using one-half of a two-way traveltime, some indication of the speed of sound in the medium and positions of the receiver and source (e.g., corresponding to the two-way traveltime).

Two-way traveltime can be defined as the elapsed time for a seismic wave to travel from its source to a given reflector and return to a receiver (e.g., at a surface, etc.). As an example, a minimum two-way traveltime can be defined to be that of a normal-incidence wave with zero offset.

As an example, a seismic survey can include points referred to as common midpoints (CMPs). In multichannel seismic acquisition, a CMP is a point that is halfway between a source and a receiver that is shared by a plurality of source-receiver pairs. In such a survey, various angles may be utilized that may define offsets (e.g., offsets from a CMP, etc.). In a CMP approach, redundancy among source-receiver pairs can enhance quality of seismic data, for example, via stacking of the seismic data. A CMP can be vertically above a common depth point (CDP), or common reflection point (CRP).

As an example, a seismic survey can include points referred to as downward reflection points (DRPs). A DRP is a point where seismic energy is reflected downwardly. For example, where multiple interfaces exist, seismic energy can reflect upwardly from one interface, reach a shallower interface and then reflect downwardly from the shallower interface. Referring to FIG. 2, the technique 210 is illustrated with p2 being deeper than p1 such that a DRP exists along p1.

As an example, a seismic survey may be an amplitude variation with offset (AVO) survey. Such a survey can record variation in seismic reflection amplitude with change in distance between position of a source and position of a receiver, which may indicate differences in lithology and fluid content in rocks above and below a reflector.

AVO analysis can allow for determination of one or more characteristics of a subterranean environment (e.g., thickness, porosity, density, velocity, lithology and fluid content of rocks, etc.). As an example, gas-filled sandstone might show increasing amplitude with offset; whereas, a coal might show decreasing amplitude with offset. AVO analysis can be suitable for young, poorly consolidated rocks, such as those in the Gulf of Mexico.

As an example, a method may be applied to seismic data to understand better how structural dip may vary with respect to offset and/or angle as may be associated with emitter-detector (e.g., source-receiver) arrangements of a survey, for example, to estimate how suitable individual offset/angle gathers are for AVO imaging. A gather may be a collection of seismic traces that share an acquisition parameter, such as a common midpoint (CMP), with other collections of seismic traces. For example, consider an AVO survey that includes a plurality of emitter-detector arrangements (e.g., source-receiver pairs) with corresponding angles defined with respect to a common midpoint (CMP). Given a CMP, acquired survey data may be considered to cover a common subsurface region (e.g., a region that includes the midpoint).

As an example, a method can include taking into account one or more considerations of offset and/or reflection point(s) for primaries and for multiples where, for example, one or more considerations may differ for a primary or primaries compared to a multiple or multiples. As mentioned, factors such as angles can differ for multiples as well as reflection point(s), as a multiple is associated with more than one reflection point. Such factors can be utilized to improve imaging, for example, by filling in a primary coverage gap, more closely approaching an object (e.g., a geobody), more closely approach an obstruction, etc.

As to a formation that is anisotropic, use of multiples may provide information that can be utilized to determine or otherwise characterize anisotropy. For example, anisotropy may be better characterized where information is acquired at one or more particular angles. In such an example, an angle of a multiple may be associated with energy passing through a layer of material in a manner that can elucidate type of anisotropy or, for example, having seismic data for more angles that provided by primaries alone can help to elucidate anisotropy. Anisotropy can be a variation of a property of a material with the direction in which it is measured. In rocks, variation in seismic velocity measured parallel and perpendicular to bedding surfaces can be indicative of anisotropy. However, in a seismic survey, angles directly parallel and directly perpendicular may not be readily available. As an example, use of one or more multiples may help to enhance angle coverage. As an example, certain types of multiples may be associated with a layer of material for which anisotropy is to be better understood. As an example, one or more multiples may be selected that are for seismic energy that passes multiple times through a layer, whether one a receiver side, a source side or a receiver side and a source side. As an example, a layer of material can include one or more platy minerals such as micas and clays that tend to align parallel to depositional bedding as sediments are compacted; noting that anisotropy tends to exist in various shales.

As an example, a multiple model or multiples models may be utilized for one or more purposes. For example, consider multiple attenuation where energy (e.g., signal) of various multiples is to be reduced. As another example, consider multiple analysis where a multiples model or multiples models may be analyzed for information that they may include (e.g., with respect to depth, acquisition quality, acquisition footprint, acquisition arrangement, structures, anisotropy, etc.).

As explained, in seismic surveying, a seismic source is used to produce seismic signals that are propagated into a subterranean structure. In some implementations, the seismic source can be in the form of a seismic vibrator, which has at least one moveable element that is actuated to oscillate between different positions to cause vibrations that cause production of seismic signals that are propagated into the subterranean structure.

As an example, a seismic vibrator can be configured to emit swept-frequency signals, where signals output by the seismic vibrator are swept from a first frequency to a second frequency, which may be from high to low, low to high or, for example, a random order. A signal sweep produced by a seismic vibrator may be an oscillating signal of a continuously varying frequency, for example, increasing or decreasing monotonically within a given frequency range. As an example, a frequency of a seismic sweep may start low and increase with time (an upsweep), a frequency may begin high and gradually decrease (a downsweep), or, as mentioned, a random approach may be utilized.

To produce a frequency sweep, control input to a seismic vibrator can include input signals that sweep across frequencies from a first frequency to a second frequency (e.g., a sweep range). In various instances, with swept-frequency signals, a short section of the output acoustic (seismic) signal from the seismic vibrator does not contain content from the entire sweep range, but is restricted to a smaller bandwidth.

As an example, rather than producing swept-frequency seismic signals, a seismic vibrator can produce a continuous seismic signal that has content over a predetermined frequency bandwidth that includes a range of multiple frequencies. For example, a substantial section (e.g., 50 percent or less) of a continuous seismic signal can have frequency content over substantially an entire predetermined bandwidth, in contrast to a swept-frequency signal where the bandwidth of that section will be smaller than the entire source bandwidth. For example, if the sweep-rate of the swept-frequency signal is constant, the bandwidth of half of the signal will be close to one half of the bandwidth of the entire signal. For non-linear sweeps, the fraction may be greater or less than half. During general land seismic vibrator acquisition, both the vibrator and the seismic receivers are stationary during the sweep; thus, all the data from one sweep corresponds to a single shot point and a single receiver point. In contrast to a land survey, as explained with respect to the examples of FIG. 3, seismic acquisition can occur where a vibratory source may be activated while either the source is moving, or at least some of the receivers are moving, or both. As explained, in a marine acquisition one or more sources can be towed behind a vessel, and the receivers may either be towed or stationary (e.g., consider ocean bottom nodes (OBNs)). Another example is transition zone acquisition where the source may be on-land and stationary and the receivers on the water and moving- or vice-versa. Moving sources and receivers are also possible on land-techniques according to some implementations are also applicable to such arrangements.

As used here, “continuous” is intended to refer to continuous or near continuous. A continuous seismic signal produced by the seismic vibrator in a seismic survey means that the seismic vibrator is continuously on (activated) during the seismic survey. However, continuous also refers to situations where the seismic vibrator is not activated during the entire seismic survey. For example, the seismic vibrator can be activated for a sufficiently length of time such that the seismic vibrator continuously outputs a seismic signal for multiple shot points. In various types of surveys, shot points may be 25 meters apart. For example, if a marine vessel towing a seismic vibrator and seismic receivers covers 200 m while the seismic vibrator is outputting a signal, then eight different shot points are produced and thus the seismic vibrator in this example would be considered to produce a near-continuous seismic signal. In some implementations, a continuous seismic signal with content over a predetermined frequency bandwidth can be designed so that the auto-correlation of the signal drops off with time.

To activate a seismic vibrator according to some embodiments, a pilot signal having a predetermined waveform can be provided to the seismic vibrator. In some implementations, a pilot signal can be in the form of a time series (e.g., a time t, the output is f(t), where f( ) is a predefined function). A pilot signal can control actuation of a seismic vibrator. A continuous seismic signal output by a seismic vibrator generally follows a predetermined waveform of a pilot signal. In some implementations, control circuitry in a seismic vibrator may include a feedback control loop that attempts to minimize or reduce the difference between the pilot signal and the output signal (the continuous seismic signal) of the seismic vibrator.

In the examples of FIG. 3, the paths are illustrated as single reflection paths for sake of simplicity. In the environments illustrated, additional interactions, reflections can be expected. For example, ghosts may be present. A ghost can be defined as a short-path multiple, or a spurious reflection that occurs when seismic energy initially reverberates upward from a shallow subsurface and then is reflected downward, such as at the base of weathering or between sources and receivers and the sea surface. As an example, seismic survey equipment can include a streamer (or streamers) that is configured to position receivers a distance below an air-water interface such that ghosts can be generated where upgoing energy impacts the air-water interface and then reflects downward to the receivers. In such an example, a process may be applied that aims to “deghost” seismic data. Deghosting can be applied to marine seismic survey data where such a process aims to attenuate signals that are downgoing from an air-water interface (i.e., sea surface interface). As mentioned, one or more other techniques, technologies, etc., may be utilized for seismic surveying (e.g., ocean bottom cables (OBC), ocean bottom nodes (OBN), etc.).

Some examples of techniques that can process seismic data include migration and migration inversion, which may be implemented for purposes such as structural determination and subsequent amplitude analysis. In seismic exploration, signal can be defined as a part of a recorded seismic record (e.g., events) that is decipherable and useful for determining subsurface information (e.g., relevant to the location and production of hydrocarbons, etc.). Migration and migration inversion are techniques that can be used to extract subsurface information from seismic reflection data.

As an example, a migration technique can include predicting a coincident source and receiver at depth at a time equal to zero; an approach that may be extended for heterogeneous media and to accommodate two-way propagation in a local sense at points from the source to a target reflector and back from the reflector to the receiver and in a global sense, separately for each of the two legs from the source to the reflector and from the reflector to the receiver. Such an approach for two-way wave propagation migration may provide for quantitative and definitive definition of the roles of primaries and multiples in migration where, for example, migration of primaries can provide subsurface structure and amplitude information.

Various techniques that can be used to predict a wavefield inside a volume from measured values of a field on a surface surrounding the volume may involve Green's theorem. Green's theorem may be implemented, for example, as part of a process for a finite volume model prediction of the so-called “source and receiver experiment” for two-way waves at depth. As an example, Green's theorem can predict a wavefield at an arbitrary depth z between a shallower depth “a” and a deeper depth “b”.

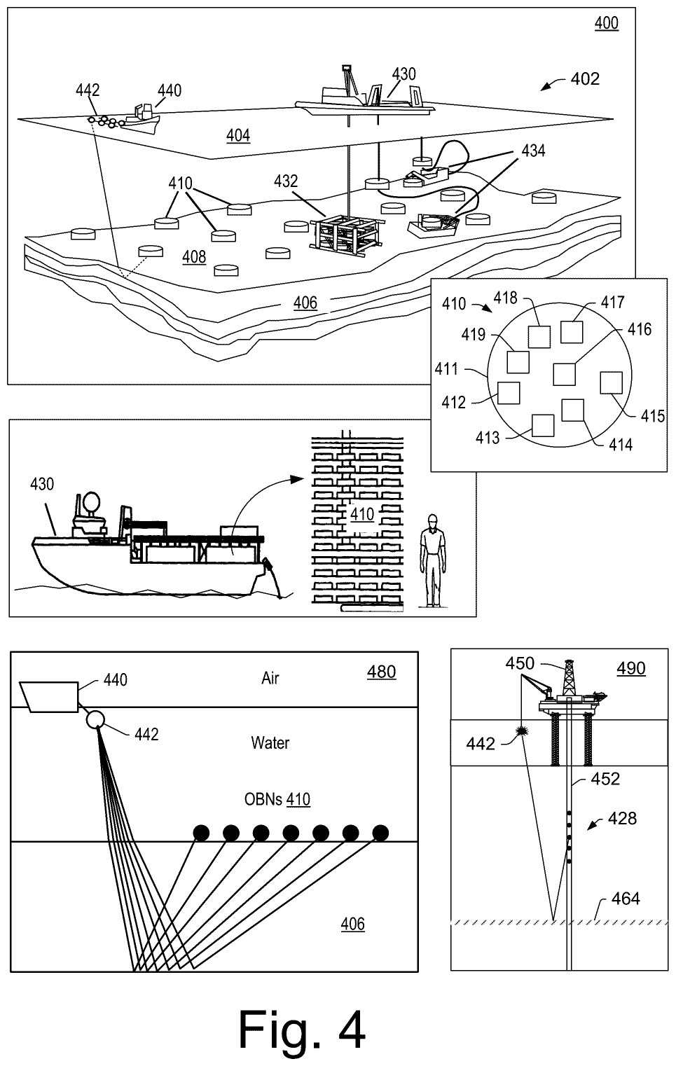

FIG. 4 shows a system 400 for acquisition of information in a geologic environment 402 that includes an air-water surface 404, a formation 406 and a seabed 408 (e.g., water-bed interface) where nodes 410 are positioned on the seabed 408. Equipment may be utilized to position the nodes 410 on the seabed 404 and retrieve the nodes 410 from the seabed 404. Such equipment may include one or more vessels 430, one or more carriers 432 and one or more vehicles 434, which may be autonomous, semi-autonomous, etc. (remotely operated vehicles (ROVs), etc.). The system 400 may include a seismic source vessel 440 that includes one or more seismic sources 442. The seismic source vessel 440 may travel a path while, at times, emitting seismic energy from the one or more sources 442. In such an approach, the nodes 410 can receive portions of the seismic energy, which can include portions that have travelled through the formation 406. Analysis of received seismic energy by the nodes 410 may reveal features of the formation 406.

In FIG. 4, the vessel 430 is shown as including nodes 410 as cargo arranged on racks. The nodes 410 can be deployed to form an array, for example, according to a survey plan. An array of nodes may be cabled or un-cabled. A cable may be relatively light weight and utilized to deploy a node receiver line with nodes coupled to the cable at spaced intervals. A rack can be utilized to securely store nodes in slots along multiple rows and columns. An individual slot may include a communications portal that can establish communication via contact(s) and/or contactless/wireless with an individual node seated in the individual slot for download of information, etc. A rack can include charger circuitry that can charge one or more batteries of an individual node seated in an individual slot. A node can be sealed such that components (circuitry, one or more batteries, etc.) are not exposed to water when the node is deployed on an underwater bed. A seal may be a hermetic seal that aims to prevent passage of air and/or water. A seal or seals can aim to prevent intrusion of water from an exterior region to an interior region of a node. Such a node can be considered to be water-tight. A sealed node can be a self-contained piece of equipment that can sense information independent of other equipment when positioned on an underwater surface that may be a seabed.

A rack may be dimensioned in accordance with shipping container dimensions such as about 3 meters by about 7 meters by about 3 meters. As shown in FIG. 4, with reference to a silhouette of a person that is about 1.8 meters in height, a node may be about a meter or less in diameter and about half a meter in height or less.

In FIG. 4, the one or more sources 442 may be an air gun or air gun array (e.g., a source array). A source can produce a pressure signal that propagates through water into a formation where acoustic and elastic waves are formed through interaction with features (e.g., structures, fluids, etc.) in the formation. Acoustic waves can be characterized by pressure changes and a particle displacement in a direction of which the acoustic wave travels. Elastic waves can be characterized by a change in local stress in material and a particle displacement. Acoustic and elastic waves may be referred to as pressure and shear waves, respectively; noting that shear waves may not propagate in water. Collectively, acoustic and elastic waves may be referred to as a seismic wavefield.

Material in a formation may be characterized by one or more physical parameters such as density, compressibility, and porosity. In the geologic environment 402 of FIG. 4, energy emitted from the one or more sources 442 can be transmitted to the formation 406; however, elastic waves that reach the seabed 408 will not propagate back into the water. Such elastic waves may be received by sensors of the nodes 410. The nodes 410 can include motion sensors that can measure one or more of displacement, velocity and acceleration. A motion sensor may be a geophone, an accelerometer, etc. As to pressure waves, the nodes 410 can include pressure wave sensors such as hydrophones.

In FIG. 4, the nodes 410 can include sensors for acquiring seismic wavefield information at the seabed 408. Each of the nodes 410 can include one or more hydrophones and/or one or more motion sensors (e.g., one or more geophones, one or more accelerometers, etc.).

A node can include various types of circuitry. Such circuitry can include circuitry that can digitize (e.g., analog to digital conversion ADC circuitry) and can include circuitry that can record signals (e.g., a microcontroller, a processor, etc., operatively coupled to memory). Each of the nodes 410 can include a housing 411, sensors 412 and 413, one or more microcontrollers or processors 414, one or more batteries 415, memory 416, ADC circuitry 417, a compass 418, communication circuitry 419, etc. As an example, a node can include one or more clocks, which may be amenable to calibration, synchronization, etc. For example, consider synchronizing to a signal, calibrating against a value, etc. As an example, a node can provide for receiving seismic energy and generating digital data that can be coded or otherwise stamped with information corresponding to time (e.g., according to one or more clocks). Various components of a node may be operatively coupled via wires, connectors, etc. A node can include one or more circuit boards (e.g., printed circuit boards, etc.) that can provide for electrical connections between various components, etc.

After deployment, one or more acoustic techniques may be utilized to determine node locations. A technique may employ acoustic pinging where acoustic pingers emit relatively high-frequency pings that are substantially above the maximum frequency of interest for seismic applications. Such relatively high-frequency acoustic signals can be picked up by one or more seismic sensors. Triangulation or one or more other techniques may be utilized to determine node locations for nodes deployed on an underwater surface such as a seabed.

Nodes may be utilized to acquire information spatially and temporally such as in a time-lapse seismic survey, which may be a four-dimensional seismic survey (4D seismic survey). A seismic image of a formation may be made for a first survey and a seismic image of the formation may be made for a second survey where the first and second surveys are separated by time (e.g., lapse in time). In such an approach, a comparison of the images can infer changes in formation properties that may be tied to production of hydrocarbons, injection of water or gas, etc.

A first survey may be referred to as a baseline survey, while a subsequent survey may be referred to as a monitor survey. To minimize artifacts in differences between seismic images from successive lapses, a monitor survey may aim to replicate a configuration of a corresponding baseline survey. Where nodes are utilized at various positions on a seabed for a baseline survey, a monitor survey may aim to place nodes on the seabed in a manner that replicates the various positions of the nodes of the baseline survey. For the monitor survey, the nodes may be the same nodes, include some of the same nodes, include some different nodes or may be different nodes. A service may have a stock of nodes that can be utilized for various surveys where once a survey is complete, the nodes are retrieved, transported and positioned for another survey. Such a service may update, replace, etc., nodes from time to time.

A position to within a few meters of accuracy of one or more nodes may be determined via one or more of GPS, an acoustic positioning system (a short-baseline (SBL) or ultra-short baseline (USBL) acoustic system), and one or more other types of systems.

A node can include sensor circuitry for acquiring measurements of a seismic pressure wavefield and its gradient; consider sensor circuitry that can measure a seismic pressure wavefield and its gradient in vertical and crossline directions.

A node can include point-receiver circuitry. A point-receiver approach can combine hydrophones with tri-axial microelectromechanical system (MEMS) accelerometers. In such an approach, the MEMS accelerometers can measure a substantial bandwidth of particle acceleration due to seismic wavefields. Measurements of particle acceleration can be directly related to a gradient in a pressure wavefield. A node may include the ISOMETRIX technology, which includes point-receiver circuitry (SLB, Houston, Texas).

In the example of FIG. 4, one of the nodes 410 may be connected to one or more other nodes of the nodes 410 via a cable. A vessel may include a cable that is operatively coupled to at least one node. In the system 400 of FIG. 4, nodes may be deployed according to a survey plan in a grid pattern; consider placement of nodes on a seabed according to an x,y grid where distance between adjacent nodes may be of the order of hundreds of meters. As shown in the system 400, the seismic source vessel 440 may be employed with the one or more sources 442 that can emit energy, which can, in turn, be received via one or more of the nodes 410.

As an example, a common shot approach 480 may be utilized, as illustrated via the formation 406, the OBNs 410, the seismic source vessel 440 and the one or more sources 442. As explained, the vessel 440 can tow one or more sources at or below an air-water interface where the OBNs 410 can be positioned on a water-formation interface (e.g., a seafloor, seabed, ocean bottom, sea bottom, etc.). As shown, the energy of the source or the sources 442 passes through the water and then into the formation 406 where a portion of the energy is reflected at an interface (e.g., a reflector). As shown, energy can reflect off the interface and progress upwardly to the OBNs 410, which can be receivers that record the energy.

When seismic traces of a gather come from a single shot and many receivers, they can form a common shot gather; whereas, a single receiver with many shots can form a common receiver gather. A shot gather is a plot of traces with respect to line distance (e.g., an inline or a crossline series of receivers) with respect to time. Such a plot may be referred to as an image, which includes information about a subsurface region; noting that traces may be processed to generate one or more other types of images of a subsurface region.

Also shown in FIG. 4 is an inset of a zero-offset vertical seismic profile (VSP) scenario 490. In such a scenario, an acquisition geometry may be limited to an ability to position equipment that is physically coupled to a rig 450. As shown, for given the acquisition geometry, there may be no substantial offset between the source 442 and a bore 452. In such a scenario, a zero-offset VSP may be acquired where seismic waves travel substantially vertically down to a reflector (see the layer 464) and up to receivers 428, which may be a receiver array. Where one or more vessels are employed, one or more other types of surveys may be performed. A three-dimensional VSP may be performed using a vessel. As an example, a VSP may be performed using one or more nodes, etc.

In seismic data workflows, a process referred to as stacking may be performed, for example, to form a stack. A stack can be defined as a processed seismic record that includes traces that have been added together from different records, for example, to reduce noise, improve data quality, etc. As an example, the number of traces that may be added together during stacking may be referred to as a fold.

As an example of stacking, consider a number of sources and a number of receivers arranged on a surface with a common midpoint where reflection ray paths involve reflection off a reflector with a common reflection or depth point. In such an example, the traces recorded at the receivers may form a hyperbolic trajectory (see, e.g., the acquired data 220 of FIG. 2). These traces, with respect to the reflector (e.g., reflection recorded in the acquired data), can be moveout corrected, for example, with respect to time and offset (e.g., from the common midpoint, etc.). Once the traces are moveout corrected, they may be summed to generate an enhanced reflection. In such an example, the process of summing may be referred to as stacking (e.g., stacking a number of moveout corrected traces to generate a single representative trace). As to moveout correction, as explained, it may aim to account for the difference in arrival times or traveltimes of a reflected wave measured by receivers at different offset locations. A technique referred to as normal moveout (NMO) pertains to moveout caused by separation between a source and a receiver in the case of a flat reflector; however, if the reflector is not flat (e.g., horizontal), then a technique referred to as dip moveout (DMO) may be applied as an effect in addition to NMO. As an example, scenarios that demand static corrections may also produce moveout.

As an example, a workflow may utilize seismic data that are pre-stack seismic data. For example, consider a pre-stack angle gather. As to angle gathers, angles in angle gathers can refer to scattering angle at a reflector. For example, an incident wave can encounter a reflector at an incident wave direction and then scatter off the reflector as a scattered wave at a reflection wave direction. The scattering angle is the angle between the incident and the reflection directions. As an example, a local coordinate system may be utilized for a local angle-domain analysis. As an example, angles can include a propagation angle of a source wavefield as an incident angle and can include a propagation angle of a receiver wavefield as a reflection angle. As explained, where a reflector is dipping, a dipping angle may be utilized (e.g., to transform a coordinate system, one or more angles, etc.).

As an example, a workflow may involve seismic inversion, for example, to reconstruct locations and/or properties or rock and/or fluid. As an example, an inversion may involve seismic data and one or more types of other data (e.g., log data, etc.) to predict rock properties (e.g., lithology, fluid content, porosity, etc.) for surveyed region. As an example, such rock properties may be used to identify hydrocarbons, reservoirs, geobodies, etc.

As an example, a workflow may involve one or more types of inversion. For example, consider pre-stacking inversion and post-stacking inversion. As to post-stacking inversion, a single seismic information volume may be inverted into an acoustic impedance volume by using seismic data, well data, and knowledge of stratigraphy for interpretation. In such an approach, removal of a wavelet from seismic data can facilitate creation of a high-resolution image of a subsurface region. As an example, post-stacking inversion can utilize a data-based model along with seismic data to invert for P-impedance (e.g., acoustic impedance), which may provide for generation of porosity and/or lithology of a subsurface region. As to model-based inversion, a seismic trace (e.g., as an initial model) may be convoluted with a wavelet to generate a synthetic seismic trace. In such an approach, impedance may be confronted to a number of iterations until the difference between the inverted trace and the initial trace is reduced to a limit value.

As to pre-stacking inversion, it may be implemented to obtain multiple impedance attributes. For example, pre-stacking inversion may be implemented to change seismic data into P-impedance, S-impedance, and density by integrating well data (e.g., log data) and seismic data. Pre-stacking inversion can involve one or more of simultaneous inversion and elastic inversion, which may employ global wavelets and a background model. Pre-stacking inversion may be employed to effectively identify lithology and fluid content where such an approach can identify acoustic impedance and shear impedance. Pre-stacking inversion may be employed to estimate Vp/Vs ratio in a subsurface region. Pre-stacking inversion may utilize a linear model of AVO.

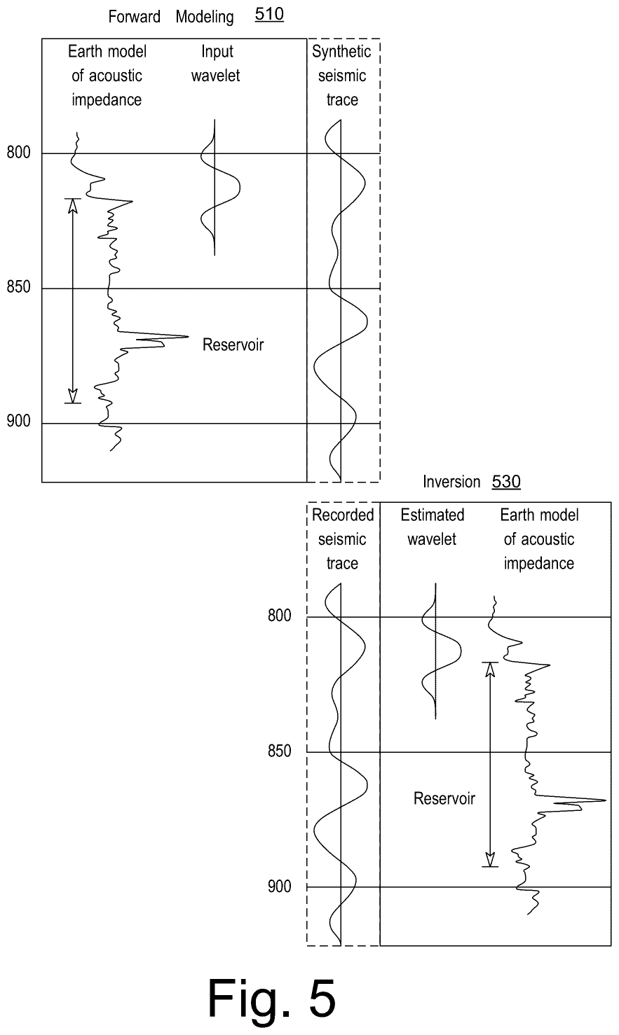

FIG. 5 shows an example of forward modeling 510 and an example of inversion 530 (e.g., an inversion or inverting). As shown, the forward modeling 510 progresses from an earth model of acoustic impedance and an input wavelet to a synthetic seismic trace while the inversion 530 progresses from a recorded seismic trace to an estimated wavelet and an Earth model of acoustic impedance. As an example, forward modeling can take a model of formation properties (e.g., acoustic impedance as may be available from well logs) and combine such information with a seismic wavelength (e.g., a pulse) to output one or more synthetic seismic traces while inversion can commence with a recorded seismic trace, account for effect(s) of an estimated wavelet (e.g., a pulse) to generate values of acoustic impedance for a series of points in time (e.g., depth).

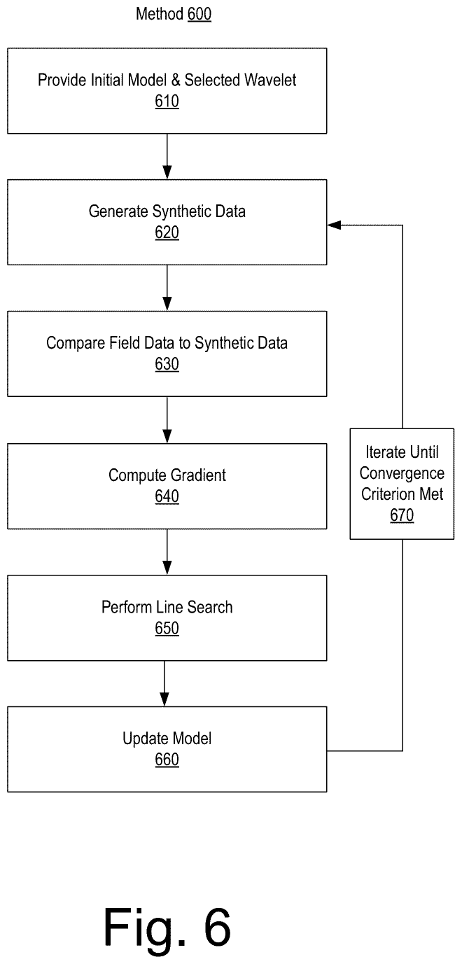

FIG. 6 shows an example of a method 600 that can perform a full waveform inversion (FWI). As shown, the method 600 includes a provision block 610 for providing an initial model and a selected wavelet, a generation block 620 for generating synthetic seismic data using the model and the wavelet, a comparison block 630 for comparing the synthetic seismic data to field seismic data, a computation block 640 for computing a gradient, a performance block 650 for performing a line search and an update block 660 for updating the model to provide an updated model, which may then be used by the generation block 620. As shown, per an iteration block 670, the method 600 can proceed in an iterative manner until one or more convergence criteria are met, which may be based on error between synthetic seismic data and field seismic data. As an example, the method 600 may be implemented by a computational framework such as, for example, the OMEGA framework.

While FIG. 6 shows an example of a FWI technique, one or more other types of iterative inversion techniques may be utilized, which may include, for example, one or more of least-squares reverse time migration (LS-RTM) and image domain inversion (IDI).

As an example, one or more techniques may employ one or more wave equations. For example, a wave equation may be a formulated expression that can represent wave displacement and wave velocity (V) as functions of space (e.g., x, y, z) and time (t). As an example, a framework may employ a wave equation with angle-dependent model parameters. In such an example, the wave equation may be applied in a full waveform inversion (FWI), for example, as to a pre-stack angle gather.

FWI is a technique that can be employed for estimating geological parameters, for example, by matching observed seismic data with numerically modeled data. FWI may utilizes data discrepancies between observation and synthetic numerical simulation results to compute model updates, which may then be used to iteratively refine model parameters representing the Earth's subsurface properties.

However, FWI can encounter challenges when attempting to generate angle gathers, which can be relevant to amplitude versus offset and/or amplitude versus angle (AVO and/or AVA) workflows. Generally, a FWI procedure can include two main phases during each iteration: a modeling phase, where simulated data are generated, and an imaging phase, responsible for gradient computation (e.g., a model update phase). While various approaches have been employed to address imaging for angle gathers, a FWI modeling phase can pose a distinct difficulty due to an inherent limitation of a wave equation. In general, a wave equation is utilized that lacks the necessary control to accurately model propagation of seismic waves in arbitrary directions. This limitation impedes the ability of FWI to iteratively enhance these angle gathers during inversion iterations. As a result, alternative methodologies often turn to the use of surface offset gathers as based on the source and receiver distance to limit the collection of seismic data. Unfortunately, such an approach demands individual modeling runs for each gather, which is computationally expensive (e.g., increasing with the number of gathers). Moreover, it demands additional efforts to convert surface offset gathers into subsurface angle gathers for subsequent AVA analysis.

To address various challenges, a framework may involve direct modification of earth model parameters into angle-dependent model parameters in a wave equation such that wave propagation may be in a number of desired or arbitrary directions. As an example, an angle-dependent model parameter may be considered as a function of incident and reflection directions, affecting wave propagation only in a specific direction. Implementation of such an approach may be achieved through wavefield decomposition and/or binning, for example, before and after coupling a spatial-varying velocity model with a seismic wavefield. As an example, a framework may employ a wave equation with angle-dependent model parameters that allows for modeling wave propagation in one or more desired directions.

As explained, some approaches exist to address challenges inherent in obtaining accurate angle gathers for AVO and/or AVA analyses. For example, to avoid using surface offset gather, angle-dependent reflectivity models may be introduced and integrated into a wave equation and inverted using one of two techniques: Least-squares Reverse-Time Migration (LSRTM) and FWI. Both of these techniques use the adjoint-state method to iteratively update angle-dependent reflectivity models until a suitable match is achieved between the modeled (e.g., synthetic) and observed data. In LSRTM, angle-dependent reflectivity models are introduced as extra parameters in a secondary source term of Born modeling data, such as those known in the art. However, LSRTM has some drawbacks, including the requirement for quite accurate velocity models and an inability to handle complex subsurface structures. FWI, on the other hand, has the advantage of being able to handle complex subsurface structures through full-wavefield modeling. One approach may provide for direct augmentation of the acoustic wave equation with high-frequency angle-dependent reflectivity terms.

As explained, a framework may implement angle-dependent model parameters for a technique that can operate without a need for reflectivity model construction, which may, for example, provide for greater flexibility in wave propagation in arbitrary directions.

As explained, FWI may utilize a wave equation such as a conventional wave equation, which may be denoted as:

$$ℒ ( P , m ) = S , \qquad ( 1 )$$

where P represents the wavefield, m is the model parameter, and S is the source.

As explained, FWI is an iterative technique that updates the model parameters to minimize the difference between the observed and simulated data. In FWI, a goal is to find the model parameters that can reproduce the observed data as closely as possible through numerical simulation (e.g., generation of synthetic data). In the case of a least-squares objective function, the misfit between observed and simulated data can be measured by:

$${min}_{m} J ( m ) = \frac{1}{2} {‖ P ( m ) - d ‖}_{2}^{2} , \qquad ( 2 )$$

where J is a function measuring the misfit between simulation data and observed data, and where ∥·∥₂² stands for the squared L2 norm.

As an example, for the conventional wave equation, the objective function can be minimized by iteratively updating the parameters with a line-search method:

$${m}_{k + 1} = {m}_{k} + {α}_{k} {g}_{k} , \qquad ( 3 )$$

where at the k-th iteration, the model is updated with a step size αₖ and model updating direction gₖ.

In the foregoing approach, the model updating direction can be a descent direction based on a gradient computed to minimize the misfit function. In such an approach, gₖ is a function of the forward wavefield P(mₖ) and adjoint backpropagated wavefield R(mₖ):

$$\begin{matrix}{g}_{k} = F ( P ( {m}_{k} ) , & R ( {m}_{k} ) ) .\end{matrix} \qquad ( 4 )$$

As explained, a framework may employ FWI using a wave equation with angle-dependent model parameters. For example, consider a modification to a model parameter that makes it angle dependent. As an example, consider introducing incident and reflection directions, denoted by angles θᵢ and θᵣ, respectively, and defining an angle-dependent model parameter m (θᵢ,θᵣ). To incorporate this new parameter into a wave equation, a framework may provide for decomposing/binning a wavefield before and after associating it with m (θᵢ,θᵣ) using operators f(θᵢ) and f(θᵣ). Such an approach can provide the following modified equation:

$$ℒ \{ P , \int {\int }_{{θ}_{i} , {θ}_{r}} f ( {θ}_{r} ) [ m ( {θ}_{i} , {θ}_{r} ) f ( {θ}_{i} ) ] \} = S . \qquad ( 5 )$$

To simplify implementation, the foregoing equation may be approximated using a summation over a limited set of selected angles, as in, for example, the following expression:

$$ℒ \{ P , {\sum }_{i , r} f ( {θ}_{r} ) [ m ( {θ}_{i} , {θ}_{r} ) f ( {θ}_{i} ) ] \} = S . \qquad ( 6 )$$

As an example, the foregoing equation may be obtained by replacing m in the conventional wave equation with Σ_{i,r}f(θᵣ)[m(θᵢ,θᵣ)f(θᵢ)].

As an example, an objective function may be minimized by iteratively updating the angle-dependent model parameters, for example, as follows:

$${m}_{k + 1} ( {θ}_{i} , {θ}_{r} ) = {m}_{k} ( {θ}_{i} , {θ}_{r} ) + {α}_{k} {g}_{k} ( {θ}_{i} , {θ}_{r} ) , for all ( {θ}_{i} , {θ}_{r} ) , \qquad ( 7 )$$

where gₖ(θᵢ,θᵣ) is model updating direction for m(θᵢ,θᵣ). In such an example, new angle-dependent model parameters may be obtained by adding the model updating direction to the previous model, for example, for all (θᵢ,θᵣ) values.

As an example, employing the adjoint method, gₖ(θᵢ,θᵣ) can be a function of a decomposed/binned forward wavefield P(mₖ) and a decomposed/binned backpropagated wavefield R(mₖ):

$${g}_{k} ( {θ}_{i} , {θ}_{r} ) = F ( f ( {θ}_{i} ) P ( {m}_{k} ) , {f}^{†} ( {θ}_{r} ) R ( {m}_{k} ) ) . \qquad ( 8 )$$

In the foregoing equation (Eq. (8)), an update of mₖ₊₁(θᵢ,θᵣ) may be primarily determined by the forward wavefield with propagation direction θᵢ and adjoint backpropagated wavefield with propagation direction θᵣ. In such an example, the adjoint state method may promptly demonstrate that each m(θᵢ,θᵣ) in the wave equation, shown as Eq. (6), can mainly affect wave propagation with incident direction θᵢ and reflection direction θᵣ.

As an example, angle-dependent model parameters may be universally or otherwise applied to both isotropic and anisotropic media, including vertical transverse isotropy (VTI) media and tilted transverse isotropy (TTI) media. While angle-dependent model parameters can be employed for various elastic and anisotropic properties, it may be sufficient and practical to consider one of the parameters that tends to influence reflection amplitudes, such as, for example, one or more of velocity, density, and impedance, as angle-dependent for generating a pre-stack angle gather. An example, presented herein, pertains to scattering pattern using velocity as a selected parameter for angle dependence, as velocity may be a dominant parameter in AVO analysis and may exhibit an isotropic scattering pattern.

As an example, a framework may provide for consideration of a scattering pattern of angle-dependent velocity in an acoustic wave equation. For example, consider a scattering pattern, which may also be referred to as a radiation pattern, of earth parameters that has been studied to understand their directional effects on modeling seismic waves, which can facilitate determining a wave equation for full-waveform inversion (FWI) as well. To illustrate the scattering pattern of angle-dependent model parameters, consider a general constant density isotropic acoustic wave equation for pressure wavefield P given in:

$$\frac{{\partial }^{2} P}{\partial {t}^{2}} - {c}^{2} {∇}^{2} P = S , \qquad ( 9 )$$

where c is the velocity model.

The angle-dependent form of the foregoing equation (Eq. (9)) may be written as:

$$\frac{{\partial }^{2} P}{\partial {t}^{2}} - {\sum }_{i , r} f ( {θ}_{r} ) [ {c}^{2} ( {θ}_{i} , {θ}_{r} ) ( f ( {θ}_{i} ) {∇}^{2} P ) ] = S , \qquad ( 10 )$$

where c(θᵢ,θᵣ) are the angle-dependent velocities.

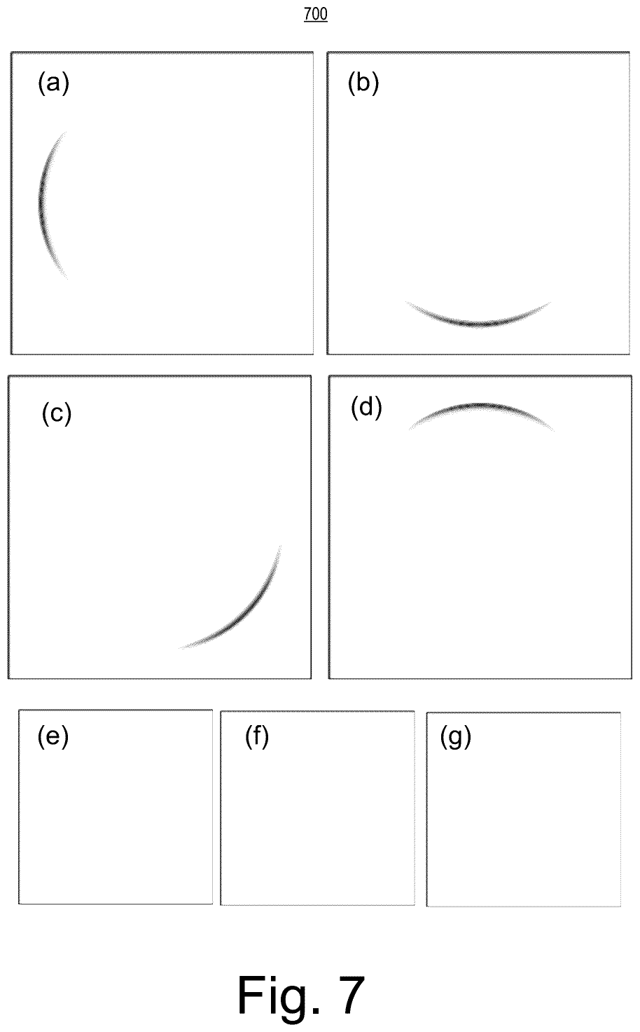

FIG. 7 shows examples of scattering patterns of angle-dependent velocities 700 with eight incident/reflection directions −135°, −90°, −45°, 0°, 45°, 90°, 135° and 180°, labeled (a), (b), (c), (d), (e), (f) and (g), respectively. In the examples of FIG. 7, wavefield decompositions are used based on these directions for operators fᵢ and fᵣ. The examples of FIG. 7 show that an incident wavefield along 0° direction, c(0°,−90°), c(0°,0°), c(0°,45°) and c(0°,180°) results in scattered wavefields along the −90°, 0°, 45° and 180° reflection directions, respectively. In contrast, c(−90°,−45°), c(−45°,45°) and c(45°,−90°) give no scattering wavefield because their incident direction does not match the direction of 0° incident wavefield. The examples of FIG. 7 validate that each c(θᵢ,θᵣ) can mainly affect wave propagation with a specific incident direction θᵢ and reflection direction θᵣ.

In FIG. 7, as explained, examples of scattering patterns of (a) c(0°,−90°), (b) c(0°,0°), (c) c(0°,45°), (d) c(0°,180°), (e) c(−90°,−45°), (f) c(−45°,45°) and (g) c(45°,−90°) are illustrated. In the examples of FIG. 7, the scattering patterns are modeled using homogenous angle-dependent velocities, except that only one c(θᵢ,θᵣ) of the multiple angle pairs utilized for each modeling includes a point scatter at the center when computing its scattering pattern (e.g., which is changed for each modeling). The modeling results of FIG. 7 use an incident wavefield along 0° incident direction (vertical downward direction).

As an example, a number of angle combinations can be selected and/or determined for purposes of a workflow that includes performing a FWI inversion. In the example of FIG. 7, both incident and reflection angles include −135°, −90°, −45°, 0°, 45°, 90°, 135° and 180°; noting that a 0° incident wavefield is in a vertical downward direction. Thus, in total, there are 64 (e.g., 8×8=64) different angle combinations. Of the possible combinations, seven are selected in the example of FIG. 7 to demonstrate how the wavefield is affected by these different directions. Again, as to the scattering patterns labeled (e), (f), and (g), there is no energy present; whereas, the scattering patterns labeled (a) to (d) do show energy being present.

As an example, a framework may provide for modeling examples of reflection-amplitude variation. For example, for the sake of simplicity, consider assuming that angle-dependent velocities are solely a function of the incident direction, thus denoted as c(θᵢ). Under such an example of an assumption, Eq. (10) may be simplified to:

$$\frac{{\partial }^{2} P}{\partial {t}^{2}} - {\sum }_{i} {c}^{2} ( {θ}_{i} ) ( f ( {θ}_{i} ) {∇}^{2} P ) = S . \qquad ( 11 )$$

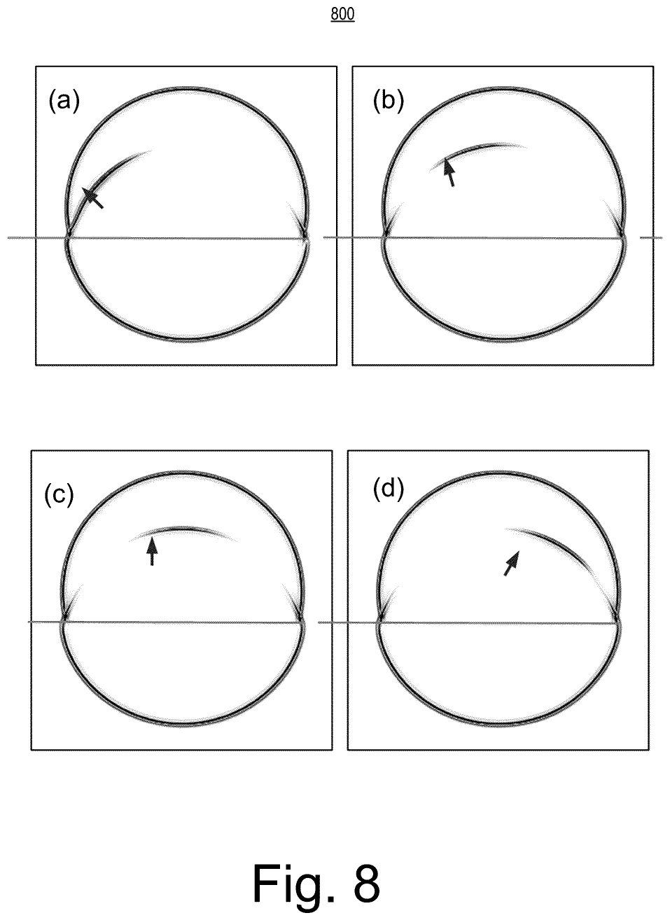

FIG. 8 shows four examples of wavefield snapshots 800 as simulated using angle-dependent velocities with a layered contrast in (a) c(−45°), (b) c(−15°), (c) c(0°), or (d) c(30°). In the examples of FIG. 8, the location of layer contrast is indicated by a blue line and the source is in the top layer; noting that amplitudes of reflections are amplified with each one indicated by an arrow.

The wavefield snapshots 800 of FIG. 8 demonstrate use of Eq. (11) to simulate wave propagation when one of the c(θᵢ) is a two-layer medium with the remaining c(θⱼ), j≠i obtained by smoothing the two-layered medium. These results demonstrate that placing the same layer contrast in different c(θᵢ) can result in different reflection amplitude variations.

As an example, a framework may implement a technique that may also assume that angle-dependent velocities are only a function of scattering angle 40, such that velocities may be denoted as c(Δθₖ). In such an example, the scattering angle may be defined as Δθ=|θᵣ−θᵢ|, which is the angle between the incident and reflection directions, such that Eq. (10) may be written as follows:

$$\frac{{\partial }^{2} P}{\partial {t}^{2}} - {\sum }_{i , k} ( f ( {θ}_{i} - Δ {θ}_{k} ) + f ( {θ}_{i} + Δ {θ}_{k} ) ) [ {c}^{2} ( Δ {θ}_{k} ) ( f ( {θ}_{i} ) {∇}^{2} P ) ] = S . \qquad ( 12 )$$

As an example, a framework may employ one or more conditions such as, for example, stability using a lossless condition and/or a reciprocity condition. For example, to ensure stable wave propagation and reduce bias on angle-dependent model parameters, Eq. (6) may be sought to satisfy the dispersion relation, which leads to the lossless condition, which may be expressed as follows:

$${\sum }_{i , r} f ( {θ}_{i} ) ( f ( {θ}_{r} ) ) = I , \qquad ( 13 )$$

where I is an identity matrix.

As an example, a framework may, for sake of convenience, directly adopt a lossless wavefield decomposition/binning technique, such that, for example:

$${\sum }_{i} f ( {θ}_{i} ) = I and {\sum }_{r} f ( {θ}_{r} ) = I . \qquad ( 14 )$$

As an example, to obtain a wavefield propagation direction at time t during numerical simulation, a framework may operate to include certain wavefield information both backward in times (t−Δt, t−2Δt, . . . ) and forward in times (t+Δt, t+2Δt, . . . ). Such an approach may be a requirement, such as, for example, for the Hilbert transform in wavefield decomposition and the Poynting vector in wavefield binning, which may pose two challenges. For example, firstly, acquiring wavefield propagation information in the forward time may be quite difficult while numerically solving the wave equation; and, secondly, storing every wavefield snapshot may be quite impractical due to corresponding and substantial data volume.

To address the foregoing challenges, the reciprocity condition may be implemented and, for example, expressed as follows:

$$m ( {θ}_{i} , {θ}_{r} ) = m ( {θ}_{r} , {θ}_{i} ) . \qquad ( 15 )$$

The foregoing reciprocity condition may provide for simplification of a process, for example, to allow for wavefield decomposition and/or binning focused solely on wavefield polarization directions at time t, which may be denoted as operators F(θᵢ) and F(θᵣ), instead of propagation direction. Such a simplification is feasible because the following equation holds

$$f ( {θ}_{r} ) [ m ( {θ}_{i} , {θ}_{r} ) f ( {θ}_{i} ) ] + f ( {θ}_{i} ) [ m ( {θ}_{r} , {θ}_{i} ) f ( {θ}_{r} ) ] = F ( {θ}_{r} ) [ m ( {θ}_{i} , {θ}_{r} ) F ( {θ}_{i} ) ] + F ( {θ}_{i} ) [ m ( {θ}_{r} , {θ}_{i} ) F ( {θ}_{r} ) ] \qquad ( 16 )$$

when the reciprocity condition in Eq. (15) is satisfied. This equivalence may be demonstrated using one or more approaches, such as those known in the art. As an example, a wave equation with one or more angle-dependent model parameters can provide for stability where one or more conditions may be satisfied (e.g., lossless condition, reciprocity condition, etc.).

As an example, a wave equation with one or more angle dependent model parameters may be constrained using one or more conditions (e.g., lossless condition, reciprocity condition, etc.), which may facilitate implementation and provide for computational stability, etc. As an example, one or more constraints may be imposed that may simplify and stabilize a wave equation with one or more angle-dependent equations. As explained, one or more types of conditions may be imposed to reduce bias. As an example, a framework may provide for selection of and/or implementation of one or more conditions as to a wave equation that includes one or more angle-dependent model parameters.

As explained, a framework may be utilized to implement a workflow that involves a FWI for a pre-stack angle gather. As an example, one or more angle-dependent model parameters may be transformed into a pre-stack angle gather, if desired, post FWI. As an example, a conventional model parameter may be employed to compute reflectivity using the expression:

$$R ( θ ) = Z ( m , θ ) , \qquad ( 17 )$$

where the Eq. (17) corresponds to an impedance reflection formulation for acoustic waves, the Shuey's equation or the Zoeppritz equation for elastic waves, or another equation based on the specific wave-equation type used in Eq. (1); noting, again, that in a conventional FWI, the model parameter m is the same across all reflection angles θ.

As an example, a framework may adopt the reflectivity formula and modify it for FWI pre-stack angle gather as follows:

$$R ( θ ) = Z ( m ( θ ) , θ ) . \qquad ( 18 )$$

In Eq. (18), the model parameter m(θ) varies with different values of θ. In such an approach, to analyze an angle gather, it may be sufficient to consider one of the predominant parameters as being angle-dependent. As an example, in the context of the pseudo-acoustic VTI equation, the formula for pre-stack angle gather may be expressed as:

$$R ( θ ) = Z ( I ( θ ) , ε , δ , θ ) . \qquad ( 19 )$$

In Eq. (19), I(θ) represents angle-dependent impedance, while ε and δ remain non-angle-dependent anisotropic parameters (e.g., consider Thomsen parameters). As an example, a framework may provide for selection of one or more model parameters to be angle-dependent. In such an example, the framework may be run in a manner that may correspond to computational resources, time, number of runs, etc. For example, if computational resources and time are limited for a run, then the framework may utilize fewer angle-dependent model parameters where, as explained, one or more of the angle-dependent model parameters can be or include a predominant model parameter (e.g., with respect to impact of angle dependence).

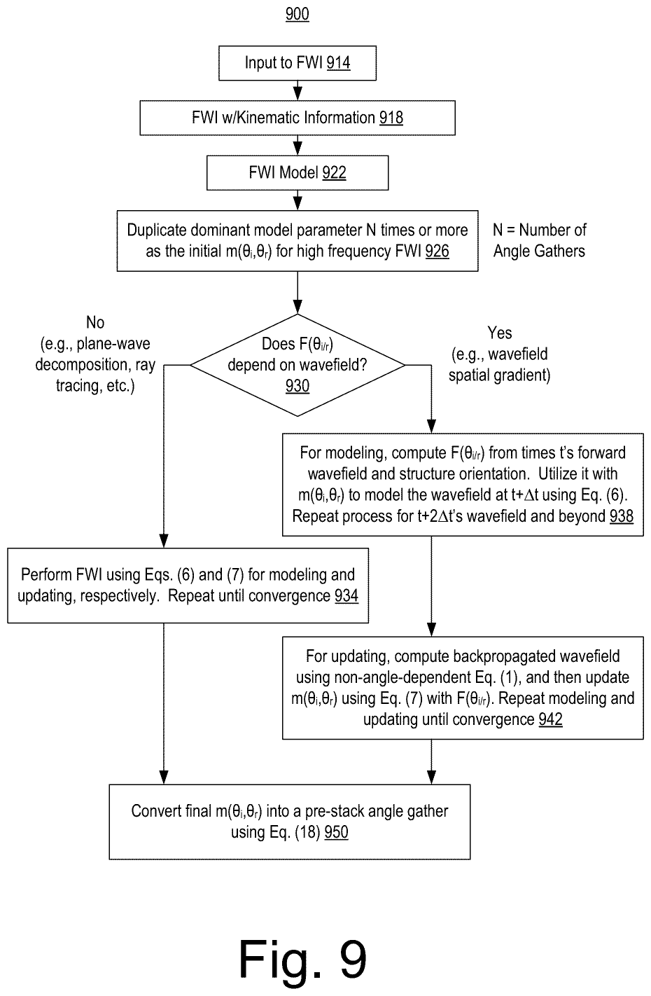

FIG. 9 shows an example of a method 900 for performing FWI for pre-stacking angle gathers using an angle-dependent model parameter. As shown, the method 900 includes an input block 914 for receiving input to a FWI technique, a FWI with kinematic information block 918 for generating a FWI process that accounts for kinematic information, and a FWI model block 922 for receiving or generating a suitable FWI model. As shown in the example of FIG. 9, the method 900 can include a duplication block 926 for duplicating the dominant model parameter N times or more as the initial angle-dependent model for high frequency FWI where N may be the number of angle gathers. As shown, a decision block 930 can follows that may be implemented according to a default, a user input, an analysis of a scenario, etc. In the example of FIG. 9, the decision block 930 decides whether an operator depends on the wavefield where, if “yes”, then a wavefield spatial gradient is utilized; otherwise, for “no”, one or more of plane-wave decomposition, ray tracing, etc., may be utilized.

As explained, the method 900 may take one or more approaches as to FWI using one or more angle-dependent model parameters. As to the “no” branch of the decision block 930, per a performance block 930, the method 900 may perform FWI using Eq. (6) and Eq. (7) for modeling and updating, respectively, while repeating until convergence (e.g., iterate until one or more stopping criteria are met). As to the “yes” branch of the decision block 930, per a computation block 938, for modeling, the method 900 may compute the operator from a time t's forward wavefield and structure orientation. In such an approach, the method may utilize the operator with the model and one or more angle-dependent parameters to model the wavefield at a subsequent time per a time increment (Δt) using Eq. (6). Such a process may be repeated for t+2Δt's wavefield and beyond. As shown, a computation block 942 can follow where, for updating, the method 900 can provide for computing the backpropagated wavefield using non-angle-dependent Eq. (1), and then update the model as to the one or more angle-dependent model parameters using Eq. (7) with the operator, while repeating the modeling of the computation block 938 and the updating of the computation block 942 until one or more convergence criteria are met.

In the example of FIG. 9, the method 900 may proceed to a conversion block 950 that can involve converting a final model with one or more angle-dependent parameters into a pre-stack angle gather, for example, using Eq. (18).

In the example of FIG. 9, the number of angles may be selected to be equal to or greater than the number of angle gathers (e.g., equal to or greater than N). As an example, a framework may provide for automatic, semi-automatic and/or manual selection of angles, which may be based on the number of angle gathers (e.g., of a seismic survey, etc.).

As explained with respect to the method 900 of FIG. 9, a spatial gradient may be utilized, for example, via proceeding along the “yes” branch of the decision block 930. Such an approach may provide for improved accuracy. As to computational simplicity, a ray tracing approach may be implemented, for example, via proceeding along the “no” branch. As an example, a framework may automatically select an operator that depends on wavefield or not and/or a framework may allow for a user to select and/or formulate an operator that depends on wavefield or not. As an example, a framework may provide for rendering of a graphical user interface that can include one or more graphical controls such that an operator may depend on wavefield or not depend on wavefield, which may thereby control the decision block 930 and the branch that the method 900 takes when performing modeling and updating. As to the computation block 942, it may be selected for computing a backpropagated wavefield using an angle-dependent approach or not, where the later may provide for increased computational efficiency. As an example, an approach may be selected automatically, semi-automatically, or manually, for example, using defaults, an analysis of a scenario, a graphical user interface, etc. As to forward propagation, where a wave equation includes one or more angle-dependent model parameters, then forward propagation computation can involve doing so in an angle-dependent manner (e.g., where backpropagation computation may or may not do so). In various scenarios, simplified backpropagation computation may be utilized without risk of lack of convergence.

As an example, a framework may provide for an implementation for a scenario involving kinematic anisotropy with a scattering angle of 0°. When a scattering angle equals 0° (θᵢ=θᵣ), incident and reflection directions align. In such a case, angle dependent parameters, f(θᵣ) [m(θᵢ,θᵣ)f(θᵢ)] offer additional control over kinematic of transmission waves, alongside anisotropic parameters. As to a kinematic condition, consider a wave equation that may model an ideal spring that extends and contracts along a single axis.

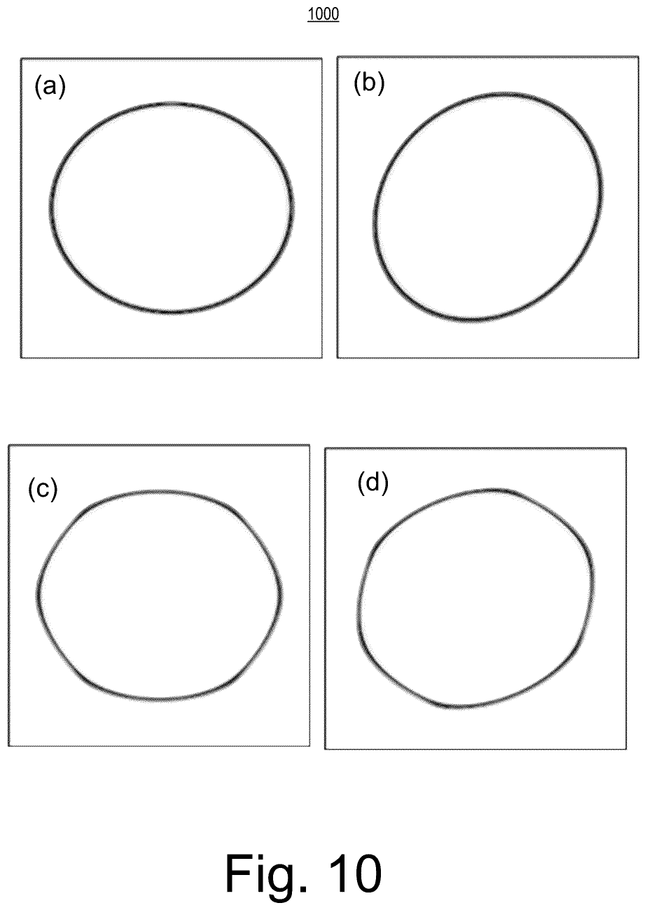

FIG. 10 shows four examples of wavefield snapshots 1000 as simulated using homogenous angle-dependent velocities with a source located at the center. Specifically, angle-dependent velocities for (a) c(0°/90°)=1850/2150 m/s, (b) c(45°/135°)=1850/2150 m/s, (c) c(0°/45°/90°/135°)=1850/2000/2150/2000 m/s, and (d) c(22.5°/67.5°/112.5°/157.5°)=1850/2000/2150/2000 m/s are shown.

The snapshots 1000 of FIG. 10 demonstrate kinematic anisotropy using Eq. (11) to simulate wavefronts with varying kinematics in different propagation directions due to the homogenous but differing values of each c(θᵢ). The snapshots 1000 of FIG. 10 show that using different homogenous c(θᵢ) can result in kinematic anisotropy.

As an example, one or more techniques may be combined for performing an inversion or inversions using seismic data. For example, consider techniques that may differ depending on one or more source and/or receiver positions, angles, etc., and/or one or more subsurface characteristics (e.g., anisotropy, depth of a reflector, number of reflectors, spatial complexity, lithologic complexity, etc.).

As explained, a framework may implement a model that includes one or more angle-dependent parameters in one or more workflows, such as, for example, one or more workflows that include using a FWI technique. As explained, such a framework may provide flexibility as to selection of one or more model parameters, for example, to control wavefield propagation concerning both incident and reflection directions, which may be performed without an explicit angle-dependent reflectivity model.

As an example, a framework may provide for control of another framework, a simulator, an inverter, etc. As an example, a framework may interact with an FWI framework, as a computational framework for executing code to perform an FWI. In such an example, the framework may provide for controlling use one or more angle-dependent parameters. In such an example, one or more technologies, techniques, etc., may be utilized to implement such control. For example, consider utilization of one or more application programming interfaces (APIs). As an example, an API may be utilized in a call and response manner. As an example, a framework may exchange information with an FWI framework to determine when, where, and/or how to implement one or more angle-dependent parameters. In such an example, seismic data, seismic survey parameters, etc., may be assessed to determine whether or not an angle-dependent parameter implementation may improve FWI. As explained, a framework may provide for improved FWI performance for AVO and/or AVA types of surveys. As explained, a framework may provide for improved FWI framework stability during execution of an FWI. In such an approach, FWI results may be improved and/or time to generate such results may be improved.

As an explained, a framework may implement one or more conditions for purposes of stabilizing a wave equation, for example, while providing flexibility to control the wavefield propagation.

As explained, a framework may provide for simplifying angle-dependent model parameters into a function of incident angles or scattering angles.

As explained, for example, with respect to the method 900 of FIG. 9, a framework may provide for implementation of a FWI workflow that can utilize angle-dependent model parameters for modeling and iterative parameter updates.

As explained, a framework may provide for implementing a FWI workflow that can utilize a final FWI inversion result to generate pre-stack angle gathers.

As an example, a framework may provide for modeling kinematic anisotropy, for example, without relying on one or more anisotropic parameters.

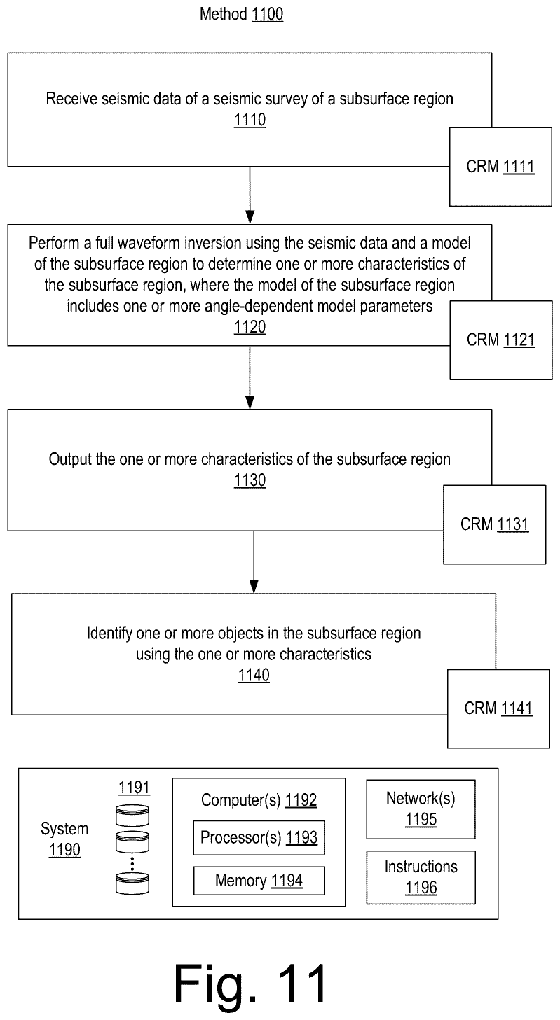

FIG. 11 shows an example of a method 1100 and an example of a system 1190 that can be a computational framework for performing one or more actions of the method 1100. As shown in FIG. 11, the method 1100 can include a reception block 1110 for receiving seismic data of a seismic survey of a subsurface region; a performance block 1120 for performing a full waveform inversion using the seismic data and a model of the subsurface region to determine one or more characteristics of the subsurface region, where the model of the subsurface region includes one or more angle-dependent model parameters; and an output block 1130 for outputting the one or more characteristics of the subsurface region. In the example of FIG. 11, an identification block 1140 may be included for identifying one or more objects within the subsurface region (e.g., hydrocarbons, a structure, etc.).

As an example, an interpretation process, machine and/or human, may operate on images or image data to facilitate structure recognition. For example, consider an iterative segmentation process that can segment image data to identify one or more structural features in a subsurface environment, where, for example, hydrocarbons may be likely to exist or proven to exist. As an example, a recognition, segmentation, interpretation, etc., type of process may operate iteratively where results can be rendered to a display such that a user may see one or more structures being more particularly identified as being improved via iterative iteration. As an example, identified structure(s) can be utilized in model building. For example, consider building an earth model that can be suitable for use in simulating one or more physical phenomena using one or more simulators.

FIG. 11 also shows various computer-readable media (CRM) blocks 1111, 1121, 1131 and 1141. Such blocks can include instructions that are executable by one or more processors, which can be one or more processors of a computational framework, a system, a computer, etc. A computer-readable medium can be a computer-readable storage medium that is not a signal, not a carrier wave and that is non-transitory. For example, a computer-readable medium can be a physical memory component that can store information in a digital format.

In the example of FIG. 11, a system 1190 includes one or more information storage devices 1191, one or more computers 1192, one or more networks 1195 and instructions 1196. As to the one or more computers 1192, each computer may include one or more processors (e.g., or processing cores) 1193 and memory 1194 for storing the instructions 1196, for example, executable by at least one of the one or more processors. As an example, a computer may include one or more network interfaces (e.g., wired or wireless), one or more graphics cards, a display interface (e.g., wired or wireless), etc. The system 1190 can be specially configured to perform one or more portions of the method 1100 of FIG. 11. As an example, instructions as in the blocks 1111, 1121, 1131 and 1141 may be included in the instructions 1196 as part of a framework such as, for example, a continuous source reflection seismology framework. Such a framework may be part of a larger framework that can include features for handling seismic survey data, generating images, generating models, etc.

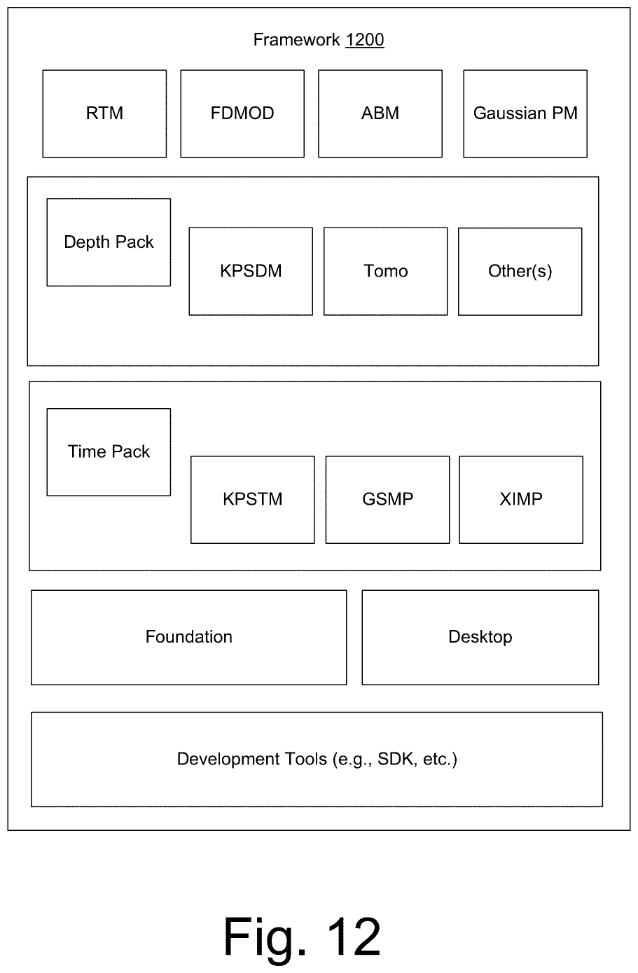

FIG. 12 shows an example of a computational framework 1200 that can include one or more processors and memory, as well as, for example, one or more interfaces. The blocks of the computational framework 1200 may be provided as instructions such as the instructions 1196 of the system 1190 of FIG. 11. The computational framework 1200 of FIG. 12 can include one or more features of the OMEGA framework (SLB, Houston, Texas), which includes finite difference modelling (FDMOD) features for two-way wavefield extrapolation modelling, generating synthetic shot gathers with and without multiples. The FDMOD features can generate synthetic shot gathers by using full 3D, two-way wavefield extrapolation modelling, which can utilize wavefield extrapolation logic matches that are used by reverse-time migration (RTM). A model may be specified on a dense 3D grid as velocity and optionally as anisotropy, dip, and variable density.

As shown in FIG. 12, the computational framework 1200 includes features for RTM, FDMOD, adaptive beam migration (ABM), Gaussian packet migration (Gaussian PM), depth processing (e.g., Kirchhoff prestack depth migration (KPSDM), tomography (Tomo)), time processing (e.g., Kirchhoff prestack time migration (KPSTM), general surface multiple prediction (GSMP), extended interbed multiple prediction (XIMP)), framework foundation features, desktop features (e.g., GUIs, etc.), and development tools.

The framework 1200 can include features for geophysics data processing. The framework 1200 can allow for processing various types of data such as, for example, one or more of: land, marine, and transition zone data; time and depth data; 2D, 3D, and 4D surveys; isotropic and anisotropic (TTI and VTI) velocity fields; and multicomponent data.

The framework 1200 can allow for transforming seismic, electromagnetic, microseismic, and/or vertical seismic profile (VSP) data into actionable information, for example, to perform one or more actions in the field for purposes of resource production, etc. The framework 1200 can extend workflows into reservoir characterization and earth modelling. For example, the framework 1200 can extend geophysics data processing into reservoir modelling by integrating with the DELFI environment and/or the PETREL framework via the Earth Model Building (EMB) tools, which enable a variety of depth imaging workflows, including model building, editing and updating, depth-tomography QC, residual moveout analysis, and volumetric common-image-point (CIP) pick QC. Such functionalities, in conjunction with the framework's depth tomography and migration algorithms, can produce accurate and precise images of the subsurface. The framework 1200 may provide support for field to final imaging, to prestack seismic interpretation and quantitative interpretation, from exploration to development.

As an example, the FDMOD component can be instantiated via one or more CPUs and/or one or more GPUs for one or more purposes. For example, consider utilizing the FDMOD for generating synthetic shot gathers by using full 3D, two-way wavefield extrapolation modelling, the same wavefield extrapolation logic matches that are used by reverse-time migration (RTM). FDMOD can model various aspects and effects of wave propagation. The output from FDMOD can be or include synthetic shot gathers including direct arrivals, primaries, surface multiples, and interbed multiples. The model can be specified on a dense 3D grid as velocity and optionally as anisotropy, dip, and variable density. As an example, survey designs can be modelled to ensure quality of a seismic survey, which may account for structural complexity of the model. Such an approach can enable evaluation of how well a target zone will be illuminated. Such an approach may be part of a quality control process (e.g., task) as part of a seismic workflow. As an example, a FDMOD approach may be specified as to size, which may be model size (e.g., a grid cell model size). Such a parameter can be utilized in determining resources to be allocated to perform a FDMOD related processing task. For example, a relationship between model size and CPUs, GPUs, etc., may be established for purposes of generating results in a desired amount of time, which may be part of a plan (e.g., a schedule) for a seismic interpretation workflow.

As an example, as survey data become available, interpretation tasks may be performed for building, adjusting, etc., one or more models of a geologic environment. For example, consider a vessel that transmits a portion of acquired data while at sea and that transmits a portion of acquired data while in port, which may include physically offloading one or more storage devices and transporting such one or more storage devices to an onshore site that includes equipment operatively coupled to one or more networks (e.g., cable, etc.). As data are available, options exist for tasks to be performed.

As an example, the framework 1200 can include one or more sets of instructions executable to perform one or more methods such as, for example, the method 1000 of FIG. 10, etc.

As an example, one or more frameworks, processes, techniques, etc., may implement machine learning and/or one or more machine learning models. For example, consider an approach that can define and/or select portions of continuous seismic source data for purposes of decomposition, windowing, etc.

As to some examples of types of machine learning and/or machine learning models that may be implemented for one or more purposes, consider one or more of a support vector machine (SVM) model, a k-nearest neighbors (KNN) model, an ensemble classifier model, a neural network (NN) model, etc. As an example, a machine learning model can be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations can be expressed as stateful dataflow graphs; noting that the name TENSORFLOW derives from the operations that such neural networks perform on multidimensional data arrays. Such arrays can be referred to as “tensors”.

As an example, a method can include receiving seismic data of a seismic survey of a subsurface region; performing a full waveform inversion using the seismic data and a model of the subsurface region to determine one or more characteristics of the subsurface region, where the model of the subsurface region includes one or more angle-dependent model parameters; and outputting the one or more characteristics of the subsurface region.

As an example, one or more angle-dependent model parameters can depend on one or more of an incident angle and a reflection angle. As an example, one or more angle-dependent model parameters can depend on an incident angle where at least two different incident angle values can be specified.

As an example, one or more angle-dependent model parameters depend on an incident direction and a reflection direction.

As an example, one or more angle-dependent model parameters can depend on a scattering angle where at least two different scattering angle values can be specified.

As an example, seismic data can include pre-stack seismic data. As an example, seismic data can include one or more angle gathers. As an example, seismic data can include pre-stack seismic data for one or more angle gathers.

As an example, a model can be or can include a wave equation model. For example, wave equation model can include one or more angle-dependent model parameters that may, for example, depend on an incident direction and a reflection direction. As an example, scattering may be defined by an incident direction and a reflection direction. As an example, a scattering angle may be defined by an incident direction and a reflection direction.

As an example, one or more angle-dependent model parameters can be or include an angle-dependent impedance parameter, an angle-dependent velocity parameter, and/or an angle-dependent density parameter.

As an example, a method may include performing a full waveform inversion (FWI) in a manner that includes generating synthetic seismic data using a model and updating the model based on the synthetic seismic data and the received seismic data where the model may include one or more angle-dependent model parameters.

As an example, a model may be constrained using one or more constraints. For example, consider one or more constraints that may include a lossless condition constraint and/or a reciprocity condition constraint. As an example, one or more constraints may increase stability of performing a full waveform inversion.

As an example, a method can include performing a full waveform inversion in a manner that includes computation of a forward propagating wavefield using one or more angle-dependent model parameters and, for example, where performing the full waveform inversion may include computation of a backward propagating wavefield without using angle-dependence of the one or more angle-dependent model parameters.

As an example, a system can include a processor; memory accessible by the processor; and processor-executable instructions stored in the memory that are executable to instruct the system to: receive seismic data of a seismic survey of a subsurface region; perform a full waveform inversion using the seismic data and a model of the subsurface region to determine one or more characteristics of the subsurface region, where the model of the subsurface region includes one or more angle-dependent model parameters; and output the one or more characteristics of the subsurface region.

As an example, one or more computer-readable storage media can include computer-executable instructions executable to instruct a computer to: receive seismic data of a seismic survey of a subsurface region; perform a full waveform inversion using the seismic data and a model of the subsurface region to determine one or more characteristics of the subsurface region, where the model of the subsurface region includes one or more angle-dependent model parameters; and output the one or more characteristics of the subsurface region.

A computer-readable storage medium (or computer-readable storage media) is non-transitory, not a signal and not a carrier wave. Rather, a computer-readable storage medium is a physical device that can be considered to be circuitry or hardware.

As an example, a computer program product can include one or more computer-readable storage media that can include processor-executable instructions to instruct a computing system to perform one or more methods and/or one or more portions of a method.

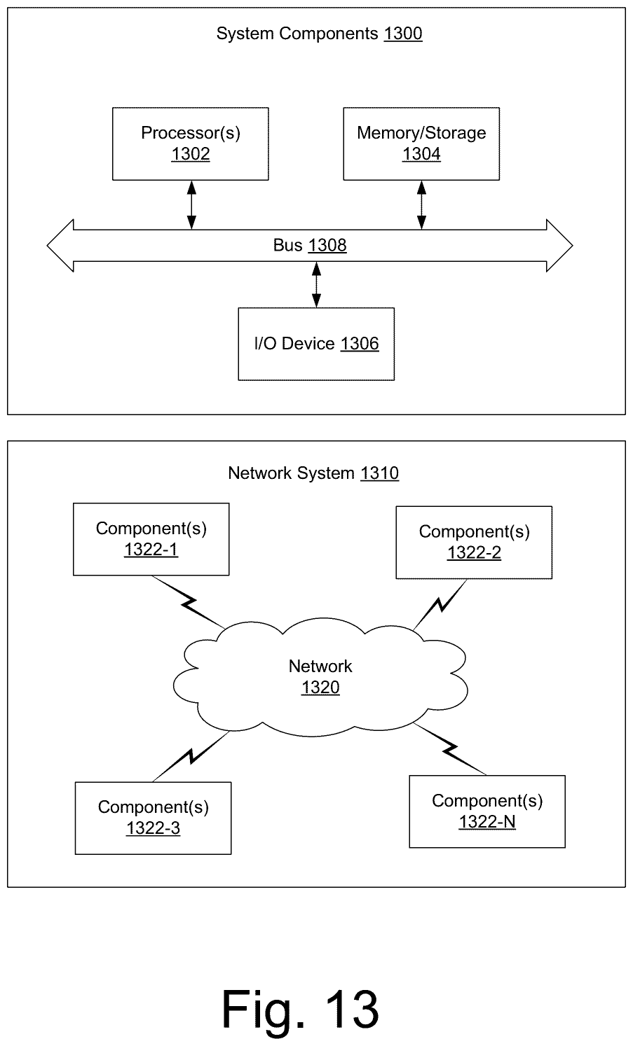

FIG. 13 shows components of an example of a computing system 1300 and an example of a networked system 1310 with a network 1320. The system 1300 includes one or more processors 1302, memory and/or storage components 1304, one or more input and/or output devices 1306 and a bus 1308. In an example embodiment, instructions may be stored in one or more computer-readable media (e.g., memory/storage components 1304). Such instructions may be read by one or more processors (e.g., the processor(s) 1302) via a communication bus (e.g., the bus 1308), which may be wired or wireless. The one or more processors may execute such instructions to implement (wholly or in part) one or more attributes (e.g., as part of a method). A user may view output from and interact with a process via an I/O device (e.g., the device 1306). In an example embodiment, a computer-readable medium may be a storage component such as a physical memory storage device, for example, a chip, a chip on a package, a memory card, etc. (e.g., a computer-readable storage medium).

In an example embodiment, components may be distributed, such as in the network system 1310. The network system 1310 includes components 1322-1, 1322-2, 1322-3, . . . 1322-N. For example, the components 1322-1 may include the processor(s) 1302 while the component(s) 1322-3 may include memory accessible by the processor(s) 1302. Further, the component(s) 1322-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few example embodiments have been described in detail above, those skilled in the art will readily appreciate that many modifications are possible in the example embodiments. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving seismic data of a seismic survey of a subsurface region;
performing a full waveform inversion using the seismic data and a model of the subsurface region to determine one or more characteristics of the subsurface region, wherein the model of the subsurface region includes one or more angle-dependent model parameters; and
outputting the one or more characteristics of the subsurface region.

2. The method of claim 1, wherein the one or more angle-dependent model parameters depend on one or more of an incident angle and a reflection angle.

3. The method of claim 1, wherein the one or more angle-dependent model parameters depend on an incident angle and wherein at least two different incident angle values are specified.

4. The method of claim 1, wherein the one or more angle-dependent model parameters depend on an incident direction and a reflection direction.

5. The method of claim 1, wherein the one or more angle-dependent model parameters depend on a scattering angle and wherein at least two different scattering angle values are specified.

6. The method of claim 1, wherein the seismic data include pre-stack seismic data.

7. The method of claim 1, wherein the seismic data include one or more angle gathers.

8. The method of claim 1, wherein the model includes a wave equation model.

9. The method of claim 1, wherein the one or more angle-dependent model parameters include an angle-dependent impedance parameter.

10. The method of claim 1, wherein the one or more angle-dependent model parameters include an angle-dependent velocity parameter.

11. The method of claim 1, wherein the one or more angle-dependent model parameters include an angle-dependent density parameter.

12. The method of claim 1, wherein performing the full waveform inversion includes generating synthetic seismic data using the model and updating the model based on the synthetic seismic data and the received seismic data.

13. The method of claim 1, wherein the model is constrained using one or more constraints.

14. The method of claim 13, wherein the one or more constraints include a lossless condition constraint.

15. The method of claim 13, wherein the one or more constraints include a reciprocity condition constraint.

16. The method of claim 13, wherein the one or more constraints increase stability of performing the full waveform inversion.

17. The method of claim 1, wherein performing the full waveform inversion includes computation of a forward propagating wavefield using the one or more angle-dependent model parameters.

18. The method of claim 17, wherein performing the full waveform inversion includes computation of a backward propagating wavefield without using angle-dependence of the one or more angle-dependent model parameters.

19. A system comprising:
a processor;
memory accessible by the processor; and
processor-executable instructions stored in the memory that are executable to instruct the system to:
receive seismic data of a seismic survey of a subsurface region;
perform a full waveform inversion using the seismic data and a model of the subsurface region to determine one or more characteristics of the subsurface region, wherein the model of the subsurface region includes one or more angle-dependent model parameters; and
output the one or more characteristics of the subsurface region.

20. One or more computer-readable storage media comprising computer-executable instructions executable to instruct a computer to:
receive seismic data of a seismic survey of a subsurface region;
perform a full waveform inversion using the seismic data and a model of the subsurface region to determine one or more characteristics of the subsurface region, wherein the model of the subsurface region includes one or more angle-dependent model parameters; and
output the one or more characteristics of the subsurface region.
